(19) United States
(12) Patent Application Publication
(10) Pub. No.: US 2019/0188788 A1
(43) Pub. Date: Jun. 20, 2019

(54) MACHINE EXECUTABLE INTELLIGENT AGENTS AND AUGMENTED REALITY

(71) Applicant: Connect Financial LLC, Wellesley, MA (US)

(72) Inventors: Charles F. Baker, IV, Brookline, MA (US); Sean Collins, Wellesley, MA (US); Tsehsin Jason Liu, Wellesley, MA (US)

(73) Assignee: Connect Financial LLC, Wellesley, MA (US)

(21) Appl. No.: 15/844,034

(22) Filed: Dec. 15, 2017

(51) Int. Cl. G06Q 40/00; G06T 19/00

(52) U.S. Cl. CPC G06Q 40/00; H04N 5/23293; G06T 19/006

(57) ABSTRACT

Among other things, records are maintained for machine-executable intelligent assistance agents. The record for an assistance agent includes information about (1) a user to which the agent belongs, (2) a domain or facet of activity of the user, (3) a goal of the assistance agent within the domain or facet of activity, and (4) a principle of conduct of the assistance agent. Each assistance agent is executed to provide assistance only to the user to which the assistance agent belongs, only in the domain or facet, and only in accordance with the goal and the principle of conduct.

This description relates to descriptions contained in U.S. patent application Ser. No. 14/304,633, filed Jun. 13, 2014; Ser. No. 14/989,935, filed Jan. 7, 2016; Ser. No. 15/231,266, filed Aug. 8, 2016; Ser. No. 15/593,870, filed May 12, 2017; Ser. No. 15/681,462, filed Aug. 21, 2017; and Ser. No. 15/681,482, filed Aug. 21, 2017, all of which are incorporated here by reference in their entirety.

### BACKGROUND

This description relates to machine executable intelligent agents and augmented reality.

A machine executable intelligent agent (also called an “intelligent agent” or sometimes simply an “agent”) can be implemented in a computer system to perform tasks for or on behalf of another party, say, another agent, another part of the computer system, or a human user. The typical activities of an intelligent agent can include ingesting information about its environment, using the ingested information together with available knowledge to make decisions aimed at achieving goals, and performing actions based on the decisions.

In augmented reality, a real-world scene, presented to a user of, for example, a mobile device, is augmented by other visible or audible elements to enhance the user's experience of the real-world scene. Those visible elements and audible elements can be features of an avatar, that is, a personification, representation, or alter ego of an abstract entity. Examples of avatars are a cartoon character representing a mythological figure or an electronic representation of a real person.

### SUMMARY

In general, in an aspect, a mobile device includes a processor, a camera, a geolocation facility, a wireless communication component, a display screen, and a storage for instructions executable by the processor to (1) cause the camera to capture a real scene in a vicinity of the mobile device at a current time, (2) cause the geolocation facility to determine the current geographic location of the mobile device at the current time, (3) present an augmented reality scene on the display screen at the current time, the augmented reality scene including at least part of the captured real scene and a representation of a financial assistance agent augmenting the real scene, (4) communicate the current geographic location to a server using the wireless communication component, (5) receive from the server information about financial assistance to be provided by the representation of the financial assistance agent in the augmented reality scene, in conformity with defined fiduciary principles, and based on known information about a financial state of a person using the mobile device at the current time, and (6) cause the representation of the financial assistance agent to provide the financial assistance in the augmented reality scene.

Implementations may include one or a combination of two or more of the following features. The instructions executable by the processor include a native app installed on the mobile device. The vicinity of the mobile device includes a place for a possible financial decision or transaction involving the user. The instructions are executable by the processor to receive from the person information about the financial decision or transaction, to communicate the information to the server using the wireless communication component, to receive from the server additional information to be provided by the financial assistance agent in the augmented reality scene as part of the financial assistance, and to cause the financial assistance agent to provide the information in the augmented reality scene. The additional information depends on a current financial state of the person. The presentation of the representation of the financial assistance agent in the augmented reality is triggered by another person related to the person using the mobile device. The financial state of the person using the mobile device includes at least one of spending, a budget, borrowing and savings. The real scene is captured by a financial assistance app running on the person using the mobile device. The representation of the financial assistance agent includes an avatar. The mobile device includes a user interface, and the instructions are executable to cause the processor to receive information from the person through the user interface about the possible financial decision or transaction. The information received from the person through the user interface indicates that the possible financial decision or transaction has been completed. The information received from the person through the user interface indicates that the possible financial decision or transaction has not been completed. The possible financial transaction may include a possible purchase. The instructions may be executable by the processor to receive from the server information about a result of an interaction between a financial assistance agent of the person using the mobile device and a financial agent of another party. The interaction includes an exchange of information. The interaction includes a negotiation. The financial assistance agent belongs to the person using the mobile device. The financial assistance agent belongs to a fiduciary assistance platform. The real scene includes at least one of a domestic element, a commercial element, an urban element, or a suburban element. The instructions are executable by the processor to cause the financial assistance agent to interact with the real scene. The instructions include an actor that conforms to an actor model. The financial assistance is provided by video, text, images, audio, or a combination of two or more of them.

In general, in an aspect, a server system includes a processor, and a storage for instructions executable by the processor to (1) store information about a financial assistance agent including an identity of a person to whom the financial assistance agent belongs, (2) receive information from a device of the person including a location of the device at the current time, (3) determine an action to be taken by the financial assistance agent based on the location of the device of the person at the current time, the action conforming to fiduciary principles, and (4) transmit information to cause a representation of the financial assistance agent being displayed as an augmentation of a real scene on the device, to act in accordance with the action to be taken by the financial assistance agent in conformity to fiduciary principles.

Implementations may include one or a combination of two or more of the following features. The fiduciary principles include acting solely for the benefit of the person. The fiduciary principles include acting without an internal perspective that is contrary to interests of the person. The action to be taken by the financial assistance agent includes an action with respect to spending, budgeting, borrowing and savings. The action to be taken by the financial assistance agent includes interaction with another financial assistance agent. The interaction includes negotiation. The transmitted information is to cause the representation of the financial assistance agent to present financial information on the device. The instructions are executable by the processor to receive financial information from the device including an input of the person received by the representation of the financial assistance agent at the device. The representation of the financial assistance agent includes an avatar. The location of the device includes a place for a possible financial decision or transaction involving the user or an augmentation of the current environment to make the decision more salient. The instructions are executable by the processor to store information about a financial state of the person at the current time and the action to be taken by the financial assistance agent is based on the financial state of the person at the current time. The financial state of the person includes at least one of spending, budgeting, saving, and borrowing. The information received from the device of the person includes information about a possible decision or transaction at the location and the action to be taken by the financial assistance agent relates to the possible decision or transaction. The instructions are executable by the processor to cause the financial assistance agent to engage in an interaction with a financial agent of another party. The financial assistance agent belongs to the person using the mobile device. There is a fiduciary assistance platform.

In general, in an aspect, an apparatus including a processor and a storage for instructions executable by the processor to (1) maintain records for machine-executable intelligent assistance agents, the record for an assistance agent including information about a user to which the agent belongs, a domain or facet of activity of the user, a goal of the assistance agent within the domain or facet of activity, and a principle of conduct of the assistance agent, and (2) cause each assistance agent to be executed to provide assistance only to the user to which the assistance agent belongs, in the domain or facet to the user, and only in accordance with the goal and the principle of conduct.

Implementations may include one or a combination of two or more of the following features. Execution of the assistance agent includes causing the assistance agent to cooperate with another assistance agent to provide the assistance. The principle of conduct includes a principle of fiduciary behavior. The principle of fiduciary behavior includes acting solely in the interest of the user. The user includes a person. The assistance includes interacting with the user through a user interface of a mobile device. The maintained record for the assistance agent includes an identifier of an assistance platform to which the agent belongs. The domain includes personal finance. The facet includes at least one of credit, savings, insurance, budgeting, spending, mortgage, investments, or credit cards. The goal of the assistance agent within the domain or facet of activity includes improving a state of the user with respect to that domain or facet. The instructions are executable by the processor to register an assistance agent as conforming to the principle of conduct. The apparatus includes an assistance platform, and at least one of the assistance agents belongs to another platform. The instructions cause two of the assistance agents to cooperate to provide assistance to the user. The cooperation of the agents includes negotiation. The assistance provided to the user includes at least one of advice, information, support, or coaching.

In general, in an aspect an apparatus including one or more processors, and storage for instructions executable by the processors to maintain records for machine-executable intelligent assistance agents, one of the agents including a personal assistance agent, the record for the personal assistance agent including information about a person to whom the agent belongs and information about a fiduciary principle of conduct of the assistance agent, execute the personal assistance agent and another agent to cause them to cooperatively provide assistance to the person in which the participation of the personal assistance agent conforms to the fiduciary principle of conduct.

Implementations may include one or a combination of two or more of the following features. The personal assistance agent and the other agent are to be executed on an assistance platform in which the person is a participant. The personal assistance agent and the other agent are to be executed by one or more processors under control of a host. The assistance is to be provided to the person with respect to a domain or facet of the person's life. The domain or facet includes a financial domain or facet. The personal assistance is to be provided through a user interface of a device of the person. The personal assistance is to be hidden from the person. The other assistance also belongs to the person. The record for the other agent includes information about another person to whom the other agent belongs and information about a fiduciary principle of conduct of the other agent, and the participation of the other agent in the cooperative providing of assistance conforms to the fiduciary principle of conduct of the other agent. The instructions are executable to cause the personal assistance agent, the other agent, and a third agent to cooperatively provide assistance to the person. The other agent belongs to another person. The third agent belongs to a third party. The personal assistance agent is executed on a fiduciary platform having a fiduciary host, and the other agent is executed on behalf of a third party. The participation of the other agent in the cooperative providing of assistance does not conform to the fiduciary principle of conduct. The third party includes a commercial entity. The cooperative assistance includes assistance in a financial domain or facet. The cooperative assistance includes assistance in a house purchase, purchase of a car, going on a honeymoon, or paying for college. The cooperative assistance includes assistance in a financial decision or transaction.

These and other aspects, features, and implementations can be expressed as methods, apparatus, systems, components, program products, methods of doing business, means or steps for performing a function, and in other ways.

Other features, objects, and advantages of the disclosure will be apparent from the description and drawings, and from the claims.

### DESCRIPTION

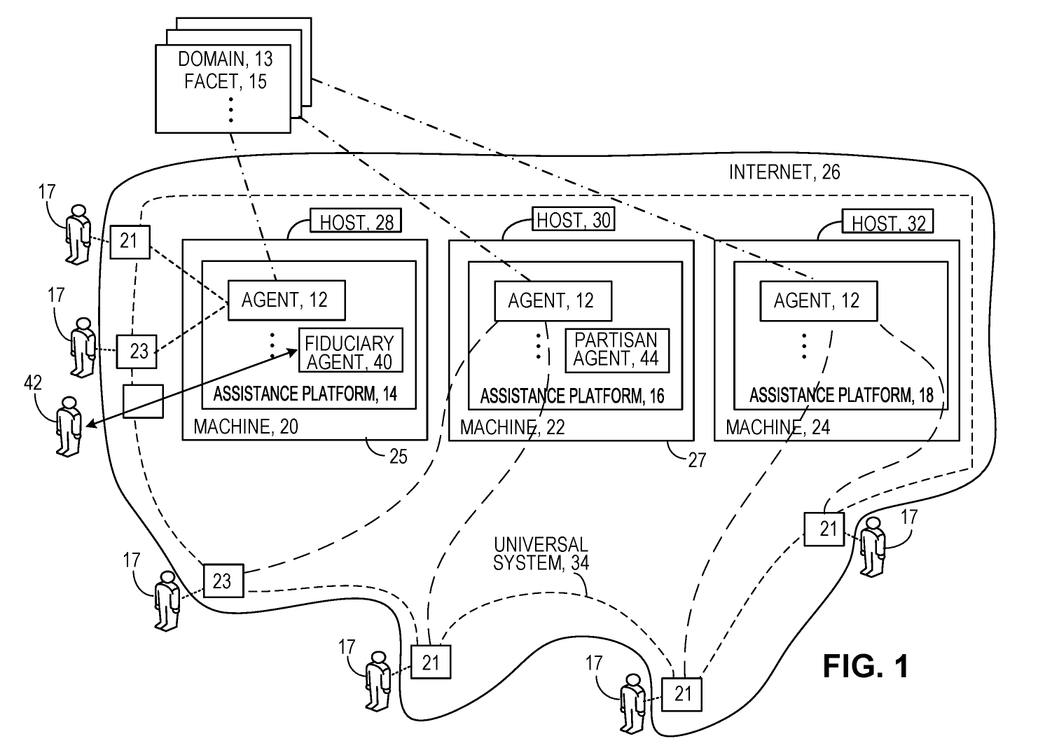

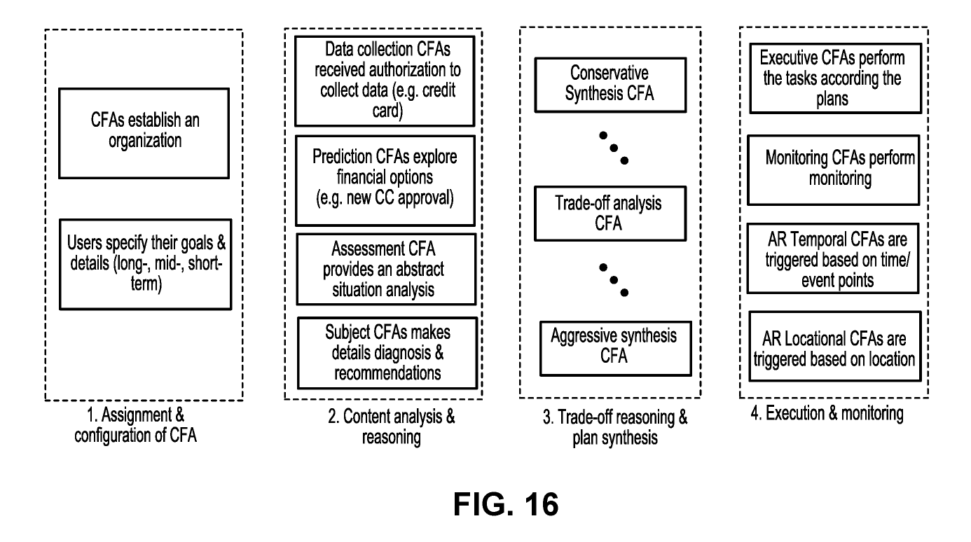

FIGS. 1 through 4, 16, and 17 are block diagrams.

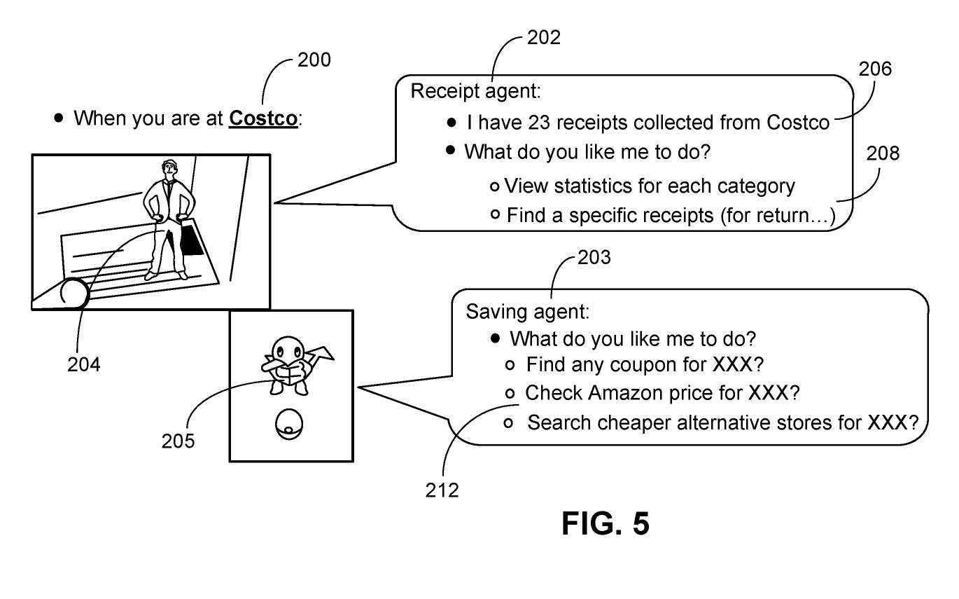

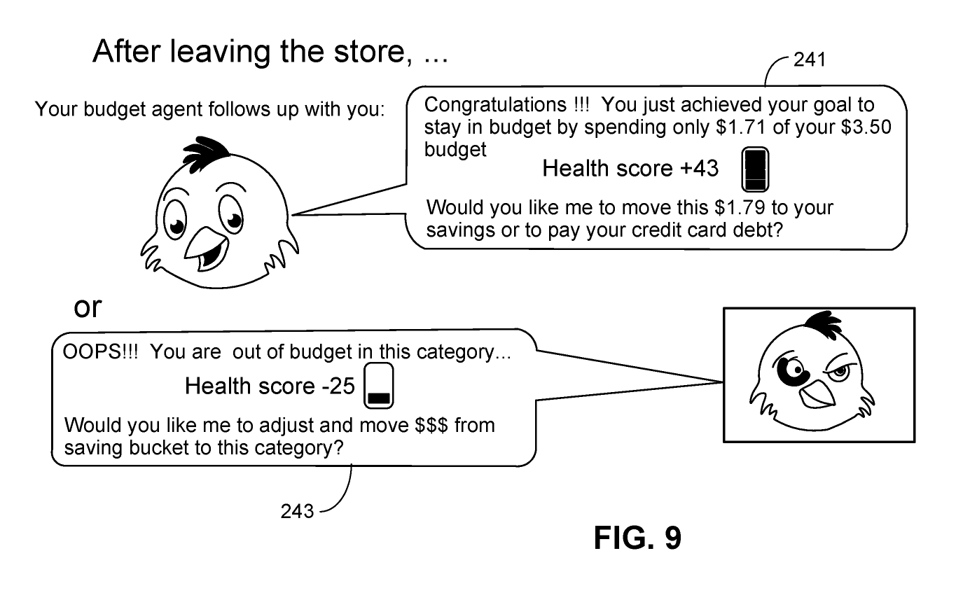

FIGS. 5, 6, 7, 8 and 9 are schematic views of agent actions.

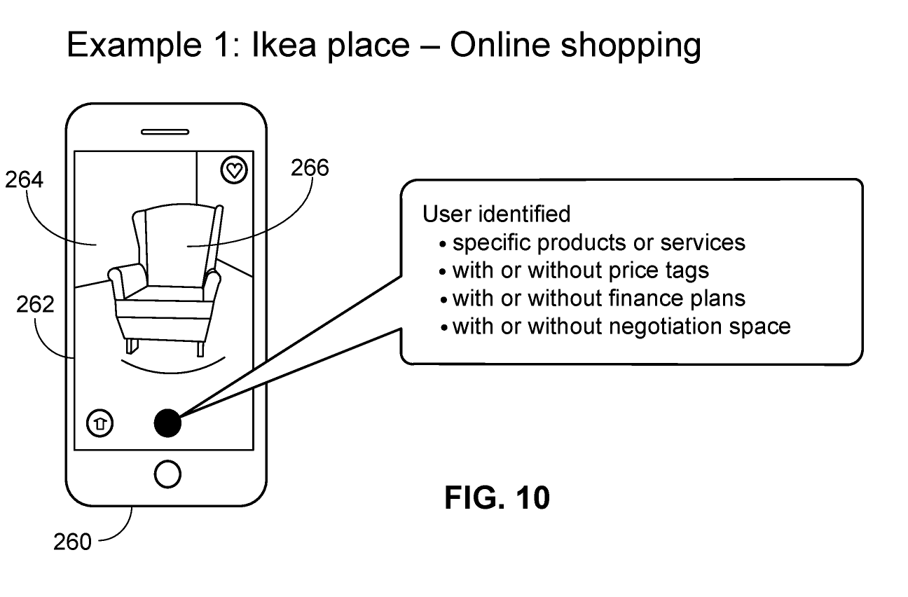

FIG. 10 is a screen display.

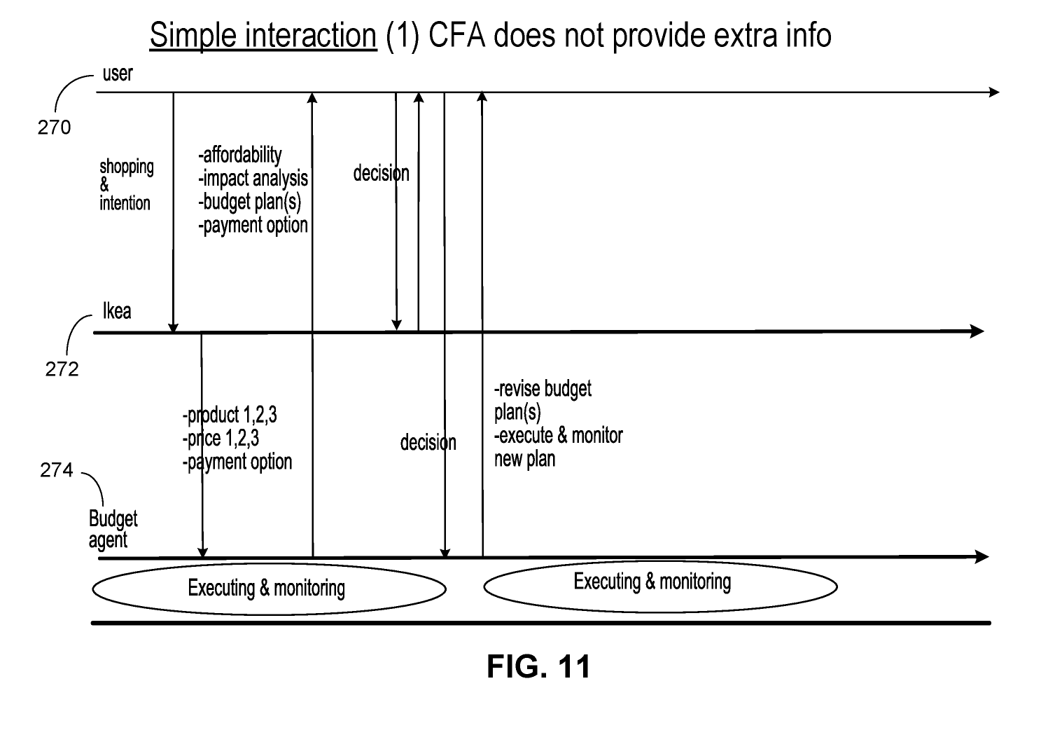

FIGS. 11, 12, 13, 14, 15, 18, 19, and 20 are coordination diagrams.

### INTRODUCTION

People often seek advice, information, and other assistance in making decisions about and taking actions with respect to events, opportunities, risks, and trade-offs in one or more domains of their lives. We use the term “domain” broadly to include, for example, any comprehensive coherent topic of interest to people, for example, athletic skills, professional development, personal relationships, or financial matters, to name a few. We use the term “assistance” broadly to include, for example, any kind of help, instruction, advice, interaction, or guidance; accumulation, aggregation, analysis, comparison, study, or processing of information; support of decision-making; development of strategies and tactics; and taking actions for the benefit of or at the request of a party being assisted, for example, in transactions, tradeoffs, or negotiations.

Assistance about such domains is commonly available to people online through portals and sites. We use the term “online” broadly to include, for example, access to any Web site through a Web browser, to resources through a mobile app, and in any other way through a network to resources at a server. The sources of the online assistance often have prejudices, domain focus, goals, or points of view that make the assistance potentially untrustworthy or unsuited to the person to whom it is presented. As a simple example, the source of the assistance may be a medical services provider interested in increasing its patient load. Advice that such a source presents to potential patients may be colored by the source's perspective, objective, and motivation. Another example is a lead generation company paid by a provider to make a recommendation. The recommendation may be biased, and the system could flag the bias to a user. In other words, sources of assistance may not conform to principles of behavior that assure the assistance is configured only to benefit the recipient and is unbiased by points of view that may conflict with those of the recipient.

In addition, assistance is often focused only on a specific facet of a particular domain in a person's life even though the circumstances in other facets of that domain may significantly affect the specific facet. We use the term “facet” broadly to include, for example, any distinct coherent aspect of a domain that is of interest to people. For example, the domain of healthy living may include facets of diet, exercise, and pain management. Assistance that focuses on diet may be incomplete and only modestly useful if it does not also take account of the exercise and pain management facets. In the financial domain, facets can include credit, savings, insurance, and budgeting among others.

Also, the modes and styles of presentation of the assistance available from online sources may make it hard or tedious or uninteresting for a person to understand and act on the assistance. Dense presentations of numbers, for example, are not easily comprehended.

Furthermore, the available kinds of online assistance are often based on insufficient or old information about the circumstances or state of a user with respect to a domain or facet. For example, assistance may be relatively useless unless the user's current weight is known when the facet of his life under consideration is exercise, or unless the user's current job title is known when the domain being addressed is professional development, or unless the current APR of a credit line of the user is known with respect to considerations in the financial domain. Similarly, if the assistance is based only on partial information, say the credit card balances of only two of a user's four credit cards, then the assistance may not be particularly useful.

These characteristics of many online assistance facilities may reduce the chances that a user will accept the assistance or will return to a given source for assistance with later decisions, and may limit the likelihood that the assistance will positively influence that domain of the person's life either currently or over a longer period of time.

Each facet or domain of a person's life has a state that in some cases can be characterized by one or more quantifiable features. The state changes over time as a result of decisions made and actions taken (or not taken) by the person (or others) that affect the values of those quantifiable features. Among those decisions and actions may be choices about transactions to engage in, allocations to be made among resources, and tradeoffs associated with alternative possible transactions or allocations. We sometimes refer to the quantified state of a facet of a person's life as the person's well-being. A person's well-being may also reflect non-quantifiable aspects of the states of facets of the person's life. One objective of providing assistance to a person in a facet of his life typically is to help him to reach a goal or accommodate a preference with respect to his well-being in that facet or across multiple facets. Such a goal or preference can be selected or stated implicitly or explicitly by the person as an aspect of seeking or receiving the assistance.

A person's overall well-being in a facet of his life can be scored based on the quantifiable (and in some cases non-quantifiable) features. Overall scores can be used to set goals and then to evaluate progress against the goals. Scoring also can be used for goal setting and progress evaluation on individual features that underlie the person's overall well-being. In some cases, scoring can apply to non-quantifiable features of a facet and be presented in non-numerical ways.

For example, in the physical fitness domain, the quantifiable features could include muscular strength, stamina, and body mass index. Transactions could include aerobic exercises, weight training, and stretching protocols. Resources could include time and money available to be devoted to fitness activities. Decisions could include choices of plans or procedures (exercise regimes) to engage in. Allocations and tradeoffs could involve how much of the resources to spend on aerobic exercises versus weight training versus stretching protocols. The person's well-being then could be his physical condition quantified by some combination of measures of his strength, stamina, and body mass index. And he could be scored from time to time based on that quantification.

For a given domain or facet, a person's well-being often depends on transactions, negotiations, and other interactions with other people or parties. Those interactions can happen in real life or through online contexts. Frequently the interactions have costs, use resources, and involve decisions. For example, in the professional development domain the interactions could involve buying educational sessions, taking time to be coached or mentored, and deciding which job to take. It is at the time and in the context of such an interaction that assistance can be especially useful to a person.

The quality of the assistance in one facet of the person's life also can depend on having knowledge of another facet. In turn, the outcome of an interaction, such as the terms reached in a negotiation in one facet, can affect the person's well-being in another facet.

The technology that we describe here provides online assistance to people with respect to domains and facets of their lives. The assistance can be provided in ways that are interesting, accessible, appealing, trustworthy, engaging, always available, presented in real time wherever the user is located, highly effective, easy to use, and continuous over any period of time (brief or long). The assistance can holistically span all or a set of facets of a person's life. In some cases, the technology can be used throughout and apply to long periods of a person's life, enabling him to improve his well-being (e.g., his overall score) continuously with respect to one or more facets of a domain taking account of changes in preferences, goals, and other factors associated with successive stages of his life.

### Implementation Overview

The technology can be implemented by software and apps running on mobile devices, computers, workstations, servers, and other machines, and can use communications carried on the Internet, cellular networks, or other networks. The devices can be located anywhere including in a central server location, in enterprises, in domestic venues, on hand-held devices, and in mobile situations.

As shown in FIG. 1, in some implementations of the technology, a population of machine-executable intelligent agents 12 provides assistance in domains 13 and facets 15 of domains to potentially large numbers of people 17 online, in real time, and wherever they are. The agents are created, maintained, managed, controlled, executed, and otherwise handled on one or more assistance platforms 14, 16, 18 (implemented for example, as software) running on one or more machines 20, 22, 24. The machines can be located together or separately and connected by communication networks, such as the Internet 26 and cellular networks. The machines can include mobile devices 21, workstations 23, servers 25, and cloud services 27. In some examples, each agent is created, maintained, managed, and controlled at only one of the assistance platforms, and we sometimes say that such an agent belongs to that assistance platform. As explained later, however, each agent can provide its assistance by activities that are not constrained to occur only at the assistance platform to which it belongs, but also can occur on more than one of the other assistance platforms or at other locations.

In a sense, the entire population of agents provides a medium for assisting a broad population of people over short or long periods with respect to a range of facets of domains that affect their lives.

In some applications, it is useful to refer to platforms that provide assistance to people using terminology that is accessible and builds confidence in the mind of the user. In the case of the domain of personal financial matters, we sometimes use the coined term “Personal Finance Office” to refer to a platform, for example, a fiduciary platform as discussed below, that provides trusted personal financial assistance. In a similar vein, we sometimes use the coined term “Client Solutions Specialist” to refer to an agent, for example, a fiduciary agent.

### Platforms and Hosts

In some implementations, each of the assistance platforms is operated or managed by a particular entity or enterprise 28, 30, 32 (“host”). The host causes or configures the assistance platform to create, maintain, manage, control, execute, and otherwise handle at least some part of the population of agents. Such agents are then said to belong to that assistance platform.

In some examples, the assistance platforms together form an assistance system 34 for the creation, maintenance, management, control, execution, and other handling of agents that provide assistance to people. In some instances, one of the assistance platforms 14 (a “governing platform”) and its host enterprise 28 (“governing host”) have special roles in providing organizational and management functions for the entire assistance system 34 of assistance platforms and their agents. In such instances, the governing platform and the governing host can have as their sole or main purpose the effective operation of the assistance system rather than any other internal business purpose. A platform that participates in the assistance system but is not the governing platform is sometimes called a “participating platform” and its host a “participating host.”

In implementations that relate to the financial domain, we sometimes use the coined term “Chief Fiduciary Officer” to refer to the host of a platform, for example, to a fiduciary host of a fiduciary platform.

### Fiduciary Principles

In some cases, all of the agents that belong to an assistance platform such as a governing platform are constrained by rules enforced by the platform during execution of the agents. The rules can require the agents to work according to one or more fiduciary principles, for example, to provide unbiased, trustworthy, fiduciary-grade assistance to people who use the assistance platform or the assistance system. We sometimes refer to agents that conform to one or more fiduciary principles as “fiduciary agents.” When all agents that belong to an assistance platform are fiduciary agents, we call the platform a “fiduciary platform” and its host a “fiduciary host”. Therefore, in many cases the governing platform will be a fiduciary platform and the governing host will be a fiduciary host.

A fiduciary agent 40 typically is bound to provide assistance only to a single particular identified person 42 and to no one else and to provide that assistance in accordance with one or more fiduciary principles. Agents that belong to participating platforms also can be (but are not required to be) fiduciary agents. In other words, within any assistance platform or the assistance system each agent individually can be a fiduciary agent or not a fiduciary agent.

An agent that is not a fiduciary agent (sometimes called a “partisan agent”) 44 may (but is not required to) provide assistance to more than one person and the assistance may be colored by a point of view and a goal that differs from and may be in conflict with the interests of the people who are being assisted.

Partisan agents can be created, maintained, managed, controlled, executed, and handled to provide assistance that yields commercial or other benefits to the parties (e.g., commercial ventures) who control the platforms to which the partisan agents belong. To achieve that result, partisan agents often necessarily have characteristics and behaviors meant to persuade, convince, or entice actions or behavior of people with whom the agents interact, in some cases contrary to the interests, perspectives, or goals of those people.

We sometimes refer to partisan agents using the coined phrase “Counterparty Solutions Specialist”.

Therefore, each of the assistance platforms (although in some cases not the governing platform, which may be strictly a fiduciary platform) can be part of or associated with other business activities of its host. For example, the host of an assistance platform could be a retailer engaged in marketing athletic shoes as its main business. Its assistance platform could provide help in the physical fitness domain to people who are customers of or otherwise registered with the retailer. That assistance can be provided to customers through agents that belong to the retailer's assistance platform and that do not necessarily conform to fiduciary principles because they operate in a way to benefit the business interests of the retailer. Such a platform can be called a “partisan platform” and its host a “partisan host.”

In addition to fiduciary principles, agents can be required to conform to other, non-fiduciary policies that define additional constraints on the assistance that they provide.

### Agent Characteristics

The main activities of an agent are to receive information relevant to its work, process the information taking account of the agent's goals and perspectives, and provide assistance (such as advice, actions, decisions, information, negotiating positions, or strategies, to name a few) aimed at improving the state of its owner (the person who is being served by the agent) in one or more specified facets of a domain.

Accordingly, a typical agent is characterized by at least the following features: (1) a user (e.g., a person or an enterprise) to whom it belongs, sometimes called its owner, (2) one or more goals and perspectives, (3) an ability to take in information relevant to the user and to a particular facet of a domain and, in some cases, real-time temporal and locational information associated with the user, (4) knowledge or beliefs about the user or about a domain or facet, (5) reasoning and inferencing capability to use the goals, perspectives, knowledge, beliefs, and other information to make decisions or generate action plans or take actions, and (6) in some cases an ability to abide by defined policies and principles (e.g., fiduciary principles) that will constrain the goals and perspectives of the agent and actions that the agent can take.

### Agent Entry Point

Before any agent (including fiduciary agents and partisan agents) can be made operational and able to perform its activities in assisting a user, the user must work through an entry point of the agent on the platform, for example, to complete a configuration that meets the requirements of the platform and the user to which the agent belongs.

The configuration of the agent can be recorded in an entry page that could list the general objective of the agent; the user's specific goal for this agent (e.g., customization of the agent's general objective to suit the user's goal); if the agent is a fiduciary agent, the fiduciary principle that the agent will follow; the intended product or outcome of the activities of the agent (such as a list of tasks, or visual charts); links to where and how a user can configure the agent to start operating on behalf of the user (for example, to provide a Social Security number, credit card number, bank account number, or other information); any required authorization, including legal form required by local government (e.g., authorization to transfer money from A to B at a specified time); and the agent's capabilities and limitations (e.g., a limitation on the age of the user to which the agent belongs).

In some cases, an agent may need to invoke the help of another agent (or its actors) to provide a particular kind of assistance to the user to whom the agent belongs. In such cases, the other needed agent (or its actors) may need to have the user to go through that other agent's entry point to finish required configurations before the other agent can begin to take actions to provide assistance to the user.

For example, in order to engage in a housing price negotiation or mortgage shopping, an agent may need to access user's credit card history. If the user does not yet have a credit card agent (and associated actors behind the scene) to provide such access, the mortgage agent has to arrange for the user to go to the credit card agent's entry point to complete the authorization.

In some cases, the configuration of the behavior of an agent may be determined by a designer or developer at design time. For example, the a designer may determine and impose different levels of difficulty for the user in taking advantage of the agent's assistance depending on the circumstances in which the assistance is sought.

### Agent Actions

With reference to agents, we use the term “actions” broadly to include, for example, any step, activity, strategy, behavior, decision, prediction, transaction, analysis, or other operation, to name a few. An action may be internal (not observable) or external (observable).

An agent action can include development or implementation of a strategy, for example, a strategy for reaching long-term abstract goals using selected short term actions. In the financial domain a long-term goal could be a high score on financial well-being including no debts. To implement a strategy to reach that goal, actions of agents could include, as one example, recommending to users to switch fee-based credit cards to no-fee-plus-cash-reward-back credit cards. Broadly speaking, the possible strategies of the population of agents and the actions of the agents in executing the strategies constitute what can be called a solution space.

Two simple examples of actions of an agent in the financial domain could include: identify available 0% interest credit cards, predict whether the users can be approved (decision making) facilitate the acquisition of the new product and process the resulting payment stream, or transfer money saved during a budget cycle to a saving account (transaction on behalf of the user). Other examples include: generating a score for an identified financial product; retrieving information indicative of scores of products; generating information to be presented on a graphical user interface (including in an augmented reality environment, discussed below); applying a filter to attributes of the candidate financial products; collecting user's preferences (including long term goals, pricing, and others); receiving information specifying that the financial service provider approves an application; receiving a request from a user for a price quotation; coordinating with other agents about trade-off analysis; and coordinating with other agents to effect negotiation. We use the term “financial product” broadly to include, for example, any good or a service in the financial domain, e.g., bank accounts, investment accounts, credit cards, insurance policies, and mortgages.

As another example of the actions that an agent could take in the financial domain, an insurance assistance agent could perform a needs assessment to determine appropriate coverage considering both auto and home insurance. The insurance assistance agent could then shop carriers to identify best prices, transfer application information to selected carriers, secure insurance, deliver confirmation to a consumer to whom the agent belongs that new insurance is in force, pay the premium on the user's behalf, update and continually monitor needs to ensure that coverage remains appropriate, and continually monitor carriers and available products to identify cost saving opportunities.

Other kinds of actions of agents are described later.

### Agent Interaction and Groups of Cooperating Agents

In some cases, assistance is provided to a person directly and solely by one-on-one actions of individual agents that belong to the person. In some situations, two or more agents that belong to a person engage in actions cooperatively with one another (for example by exchanging information or by negotiating) to provide assistance indirectly to the person. Sometimes, cooperation occurs between agents that belong to a person and agents that do not belong to the person, for the purpose of providing assistance to the person. In some instances, agents provide both direct and indirect assistance to a person. For purposes of cooperation, agents that belong to a given platform can interact directly with one another, while agents that belong to different platforms can communicate with one another using a publish-subscribe messaging model.

In some cases, agents that belong to a given platform can interact freely within the platform.

Agents that belong to two different platforms can also interact freely based on a typical publish and subscribe model. For this purpose, agents can publish throughout the assistance system information that describes the features of the agents and the actions they can perform. A subscribing agent that belongs to a platform other than the one to which a publishing agent belongs can then subscribe to a relationship with the publishing agent. Thereafter, the publishing agent and the subscribing agent can interact by messaging in order to cooperatively complete jobs. In some examples, before an agent is permitted to subscribe to a relationship with the publishing agent, the platform to which the publishing agent belongs may analyze features of the subscribing agent (for example, whether it is a fiduciary agent) and determine whether to allow the subscribing agent to subscribe.

Coordinated action of agents can be used to achieve, for example, trade-off reasoning, negotiation with third-party agents, a cooperative task that cannot be performed solely by a single agent, and other results.

Generally, to aid cooperation, agents can belong to and operate within a cooperation group of agents. The cooperation group (and the identities of its members) can be specified when the agents are created or while agents are being executed by a platform. The constituency of the group can be specified by one or more of the hosts or platforms, or solely by a governing host or governing platform. In addition to specifying the composition of a cooperation group, one or more of the hosts or platforms or other party or parties can define plans or activities of the cooperation group and its agents, allocate tasks to agents, and integrate each agent's individual plans, activities, and schedules with cooperating other agents. One or more of the platforms then causes the plans and activities to be executed to complete the tasks.

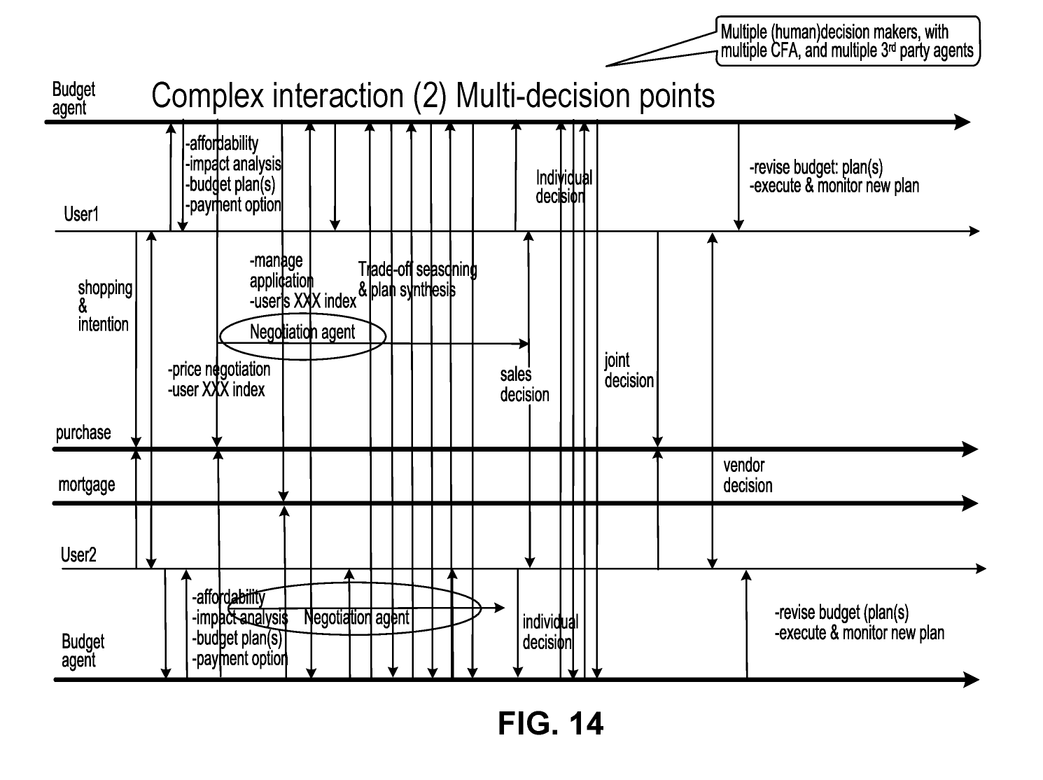

As shown in FIG. 14, for example, a group of agents (called “CFAs” in the figures) could be created to provide assistance about a person's credit cards. The person could specify short-term, mid-term, and long-term goals concerning credit cards, including reducing total credit card debt, and/or reducing rates paid for balances on one or more of the credit cards. The group could include assistance agents that would collect credit card data associated with the person, after getting authorization from the person to collect the data. Other assistance agents could perform context analysis and reasoning based on the collected data. For example, assistance agents could explore options for available credit cards for prediction purposes, assess the person's credit card situation, and make detailed diagnoses and recommendations. Other assistance agents could engage in tradeoff reasoning and synthesize plans that could be conservative or aggressive. Yet other assistance agents could take charge of execution and monitoring of plans by performing tasks according to the plans.

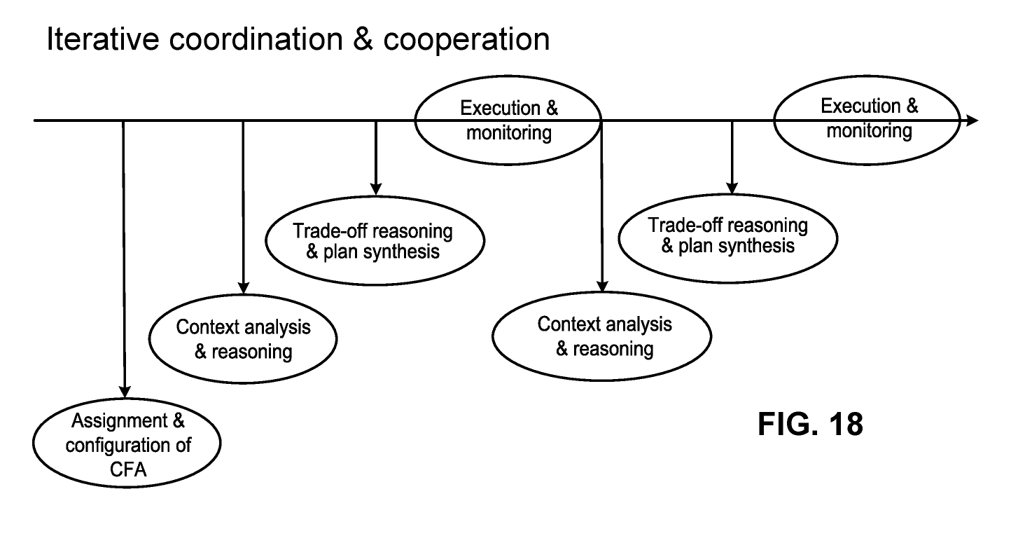

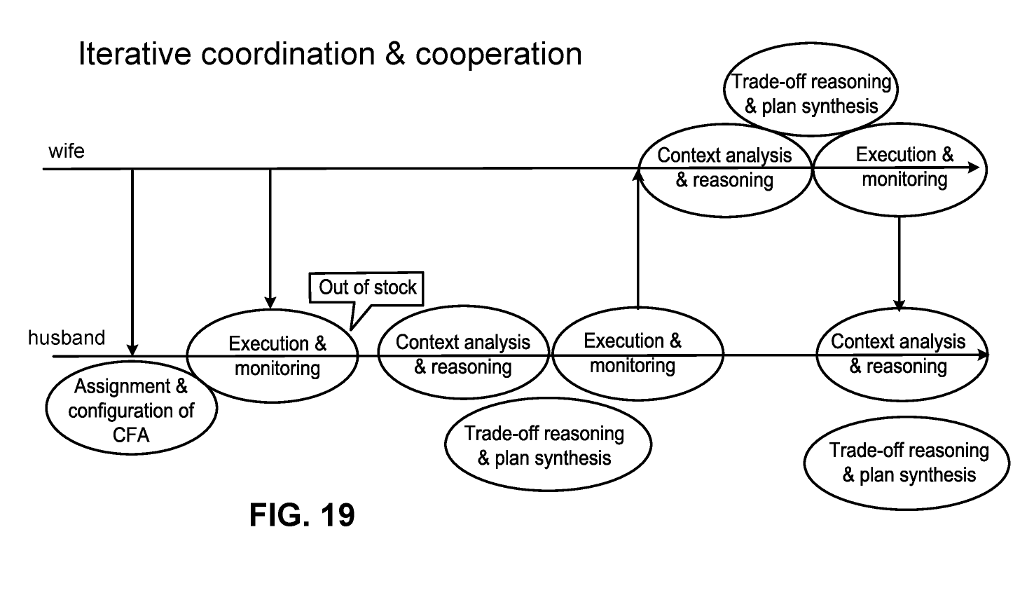

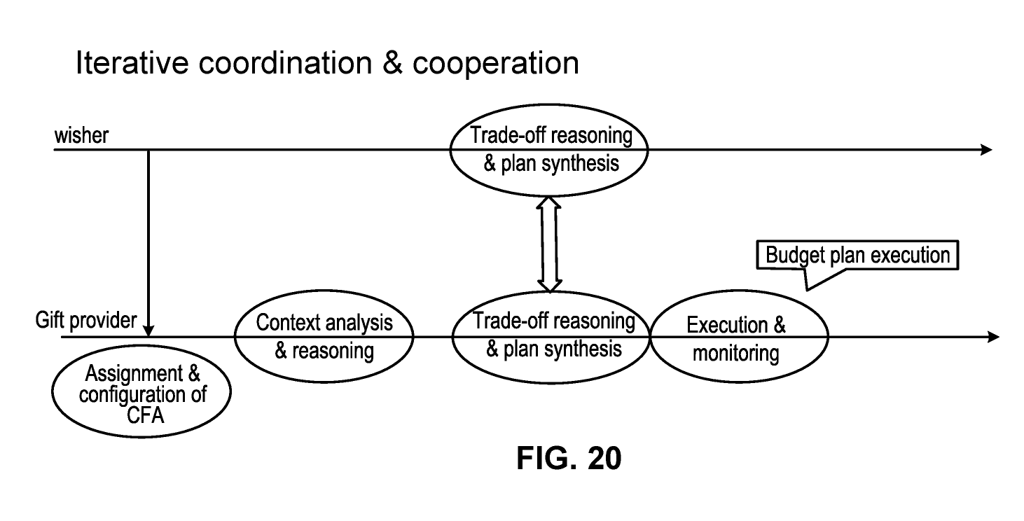

FIGS. 18, 19, and 20 illustrate actions of agents over time in three examples. FIG. 18 shows actions managed by a single assistance agent; FIG. 19 shows cooperative actions of two agents on behalf of a wife and a husband; and FIG. 20 portrays cooperative actions of two agents on behalf of a person wishing for a gift and a gift giver.

### User Authorization of Agents

With respect to at least some agents, and in particular fiduciary agents, a person to whom the agent is to belong must implicitly or explicitly be aware of the agent and its characteristics and authorize the agent to provide assistance to and on behalf of the person before the agent is created and executed. Authorization can be implied by a relationship the person has with a particular platform. For example, that relationship may imply an understanding that fiduciary agents will be created for that person as part of the assistance that is to be given by the platform.

In some cases, authorization can be provided explicitly by having the platform present information through the user interface of the person's mobile device about a proposed agent for approval. In some cases, a platform or the assistance system can present information about many available agents and enable the user to select one or more agents to belong to that user. For this purpose, the site can provide explicit lists or other information about available agents, identifying their characteristics, and the user can identify which agents she wishes to have belong to her. Once she has chosen an agent, the agent will thereafter perform the actions and make the decisions that the agent is designed to do.

In some instances, a platform may expose agents to a user through a site without explicitly describing the characteristics of the agent and without asking explicit permission for the agent to serve the user. Normally this would not be done for a fiduciary agent, but only for partisan agents. In the case of a partisan agent, an authorization may not be required, and the agent may simply provide assistance to a user as part of the user's interaction with a site presented by a platform.

In some simpler cases, in order to receive assistance from agents that belong to an assistance platform or the assistance system, a person may need to do nothing more than navigate to an online site of the platform and begin to use the assistance of an agent. The person may or may not be required to authenticate himself to login to the site and need not have authorized the agent if the agent is a partisan agent.

### Agent Records

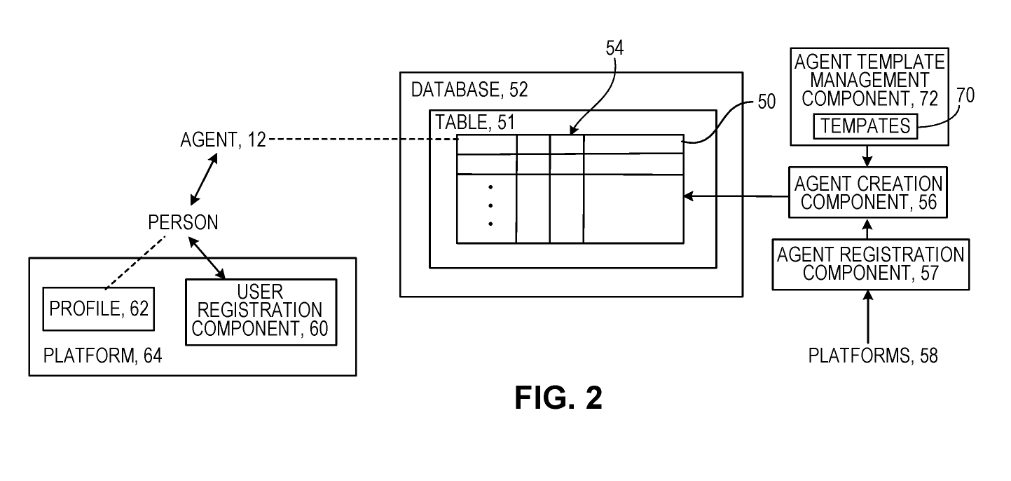

As shown in FIG. 2, in some implementations of platforms and the assistance system, information about agents 12 is kept in corresponding records 50, for example, in a table 51 of a database 52, although other storage techniques could be used. The database 52 can be maintained by a single assistance platform within an assistance system, for example, a governing platform. In some cases, the database 52 can be distributed among platforms.

Each agent 12 has a corresponding record 50 in the database. The fields 54 of the records for agents could include at least the following: a globally unique identifier for the agent; a flag indicating whether the agent is a fiduciary agent or a non-fiduciary agent; an identifier of the platform to which the agent belongs; a unique identifier of the person to whom the agent belongs; indicators of the domain and facets of the domain for which the agent provides assistance; and identifiers of goals of the agent and host-defined policies (such as fiduciary principles) that will govern the activities of the agent.

In some implementations, when an agent is created, a record for that agent is added to the database containing some or all of the identified fields. An agent creation component 56 running on one or more of the platforms can add the record. Agent records can be added in a variety of ways and under a range of circumstances. In some cases, the agent records are added under the sole initiative of a platform. For example, a participating platform can add a catalog presentation agent for a customer when the customer registers with a site served by a host of the platform.

In some instances, an agent record can be added only when such an agent has been selected by a person and specifically authorized by the person to be added.

### User Registration

In some instances, to take advantage of assistance features available from agents of an assistance platform 64 or the assistance system, a person registers by means of a user registration component 60, creates a profile 62, and becomes a participant in the assistance platform or system. The person can remain registered for any period of time. When a person logs into an assistance platform or the assistance system, she has access to all of the assistance agents that belong to or are otherwise managed by the assistance platform or the assistance system. In some cases, the assistance platform is a fiduciary platform, and the platform will expose to the participant only agents that are fiduciary agents.

In some cases, when a person is registered with a fiduciary platform that serves as a governing platform, the platform controls the interaction between the person and both the fiduciary agents of the platform and other agents that have been registered by other platforms. Those other agents may be partisan agents. In some situations, the fiduciary agents of the registered person may interact with and get assistance from partisan agents of the other platforms. The fiduciary platform can control those interactions so that the registered person is always dealing with fiduciary agents and not directly with the partisan agents.

An assistance platform (in particular, a participant platform) can register its agents with another (for example, governing) platform so that the governing platform can make those agents available to members of the governing platform or members of the assistance system. For this purpose, an agent registration component 57 can receive registration requests from other platforms 58. Each registration request can contain the information required for the fields of an agent record. Once the record has been added to the table of the database, the agent registration component can report the registration back to the requesting platform. Then, any platform on which the registration is effective can make the registered agents available for selection, authorization, or use by people.

### Agent Templates

Agents can be created individually and in groups to perform assistance tasks for people and enterprises.

Typically, a platform provides assistance of particular predefined kinds and does so by enabling the creation of corresponding agents having relevant characteristics to enable them to provide that assistance. In some implementations it is efficient for the host of a platform to define agent templates 70 from which similar individual agents can be created by the agent creation component 56 as needed. For example, in the financial matters domain, a platform may provide a budget agent to each of its participants. All of the budget agents for all of the participants may have similar (or identical) characteristics.

Therefore, each agent that is selected (and if required, authorized) by a person can be formed as an instance of an agent template and its information stored as a record in the database. For each facet of the domain to be handled by agents of a platform, the host can define a set of one or more agent templates that together define activities, policies, goals, and forms of interaction that will enable the agents spawned from those agent templates to provide useful assistance to the people to whom the agents belong, with respect to that facet of that domain.

A host of a platform can create agent templates, delete agent templates, and alter agent templates as needed. The host determines the number and characteristics of the templated agents that will exist on the platform at a given time. In defining agent templates, the host defines policies (sometimes in addition to or other than fiduciary principles) that the agents will apply. Typically, these policies will represent sensible constraints on the conduct of the agents based on the nature of the host and the roles that the agents are to play with respect to the people to whom they belong.

### Fiduciary Enforcement

Because it is important for a person to have confidence that an agent that the person understands to be a fiduciary agent actually acts according to fiduciary principles. Several mechanisms can be used to assure such conduct. When an agent template is created for use on a platform the host that creates the template can impart to the agent only actions that conform to the fiduciary principles. When the agent's information is recorded in the database, the flag indicating that the agent is a fiduciary agent will be set. When the platform is a fiduciary platform, the fiduciary host has control over the definitions of the agent templates and therefore the characteristics of agents spawned from the templates, including compliance with fiduciary principles. Therefore, a person who is a member of the platform can be confident that agents provided by the platform will be fiduciary agents. If other platforms wish to register their agents (or agent templates) with the fiduciary platform, the host of the fiduciary platform can review the actions of which the agent (or agent template) is capable and permit registration only if satisfied that the fiduciary principles will be obeyed.

In some implementations, indications (such as a certification mark) can be provided to the user through the user interface to certify that an agent providing assistance to the user is a fiduciary agent.

### Financial Assistance in Particular

Although the technology that we describe here is applicable to a broad range of domains and facets of domains of people's lives, we sometimes use examples in the domain of financial matters in our explanations. The use of these examples is not meant to imply in any way that these approaches are not also applicable in other domains.

With respect to the financial matters domain, consumers often seek advice, information, and other assistance with respect to financial decisions that apply to events and aspects of their financial situations, such as which financial products to buy, which mortgage to apply for, or how much money to save to meet retirement needs. The technology can provide financial assistance for a broad range of specific facets of this domain at various times in the lives of consumers, and also for the holistic financial conditions of consumers spanning all or a significant set of such facets. In some cases, the technology can be used by and apply to long periods of a consumer's life, including from young adulthood to old age.

Among the facets of the financial matters domain are financial resources (money or money equivalents), financial transactions (acts of spending or saving), financial decisions (the process of deciding how, when, and where to engage in financial transactions that affect financial resources), financial allocations (budgeting or other planning about proportions of resources to be devoted to various financial resources and financial transactions), and financial trade-offs. Financial assistance can apply to any or all of these facets.

Many of the facets of a consumer's financial state are affected by interactions with third parties, such as companies that sell products, provide investment vehicles, offer insurance, lend money, and provide financial advice. These interactions may happen in real life situations or online. Frequently such an interaction involves an implicit or explicit negotiation of the financial terms of a transaction and the outcome of the negotiation may (and ought to) depend on other facets of the consumer's financial state. The outcome of the negotiation, i.e., the terms of the transaction, will in turn affect other facets of the consumer's financial state.

In some implementations of the technology that we describe here, a population of machine executable intelligent agents maintained by a host platform and by third parties provides online financial assistance to consumers in a broad range of financial contexts about every kind of financial topic. In some cases, individual agents provide financial assistance directly to a consumer. In some instances, agents interact with one another (for example by exchanging information or by negotiating) to provide assistance indirectly to a consumer.

### Actors

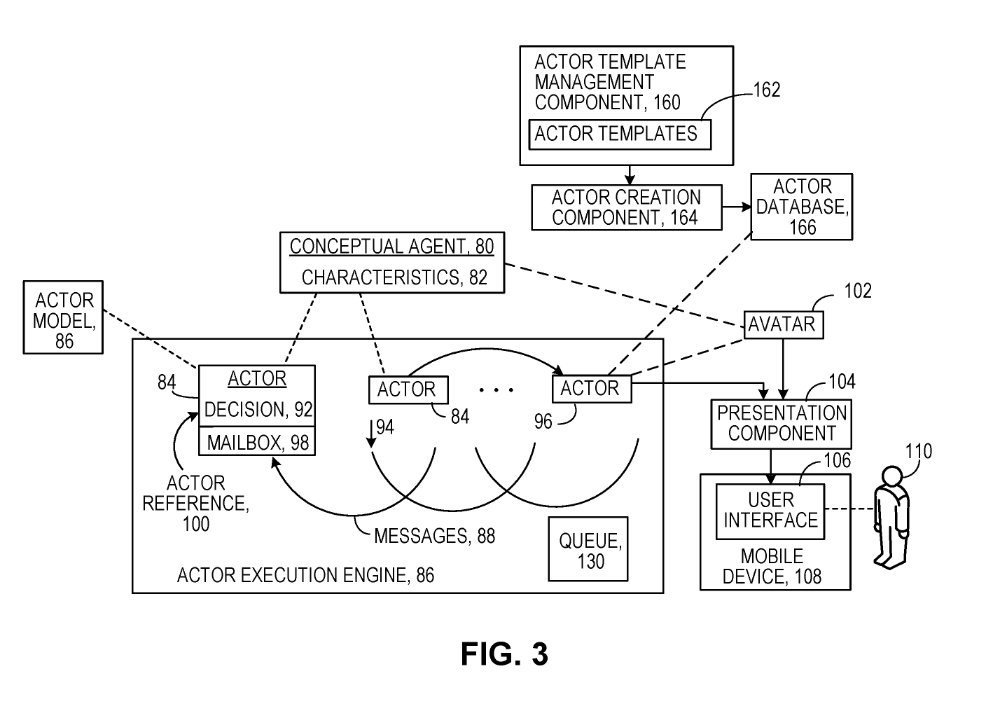

As shown in FIG. 3, although we have sometimes described agents as software structures that are directly executable by the platforms, in some implementations, an agent is only a “conceptual” entity 80 that is defined by characteristics 82 including those specified in the database record, but is not a discrete piece of executable software itself. Instead the conceptual agent does its work through the medium of software actors 84 that are executed by an actor execution engine 86 running on the platform to which the agent belongs. These actors may have some of the characteristics of actors as described in the literature for actor models in computer science.

In some implementations, an actor 84 is an executable software instance that conforms to an actor model 86. Actors perform tasks individually and in cooperation with other actors using messages 88. An actor can (1) receive messages 90, (2) make corresponding internal decisions 92, (3) send messages 94 to other actors, (4) define how it will act in response to the next received message, and (5) create new actors 96. An actor can only affect other actors and be affected by other actors through messages. The actor model enables efficient adaptable execution of tasks that are conceptually the responsibility of agents. Every agent has one or more actors through which it does its work. Not every actor must be associated with an agent, as some actors may be created to do jobs related to the operation of the system and not to the work of any particular agent. An actor can be associated with more than one agent when the actor is doing a job that is useful to all of the agents with which it is associated. Actors can be created and terminated as needed.

Each actor has a mailbox 98 for receiving messages from other actors or from the platform on which it is being executed. In some implementations, messages are immutable, and once the actor reads a message, the message is removed from its mailbox. In some cases, an actor can send a message to a target actor, and the target actor takes up the message from the mailbox asynchronously to the sending of the message by the first actor.

Each actor has a globally unique actor reference that is used by other actors and platforms to refer to, send messages to, and otherwise interact with the actor. An actor has access to its context by which it can find information about the outside world, including information about people who are participants on the platform where it is being executed.

The communication protocol used for messaging can be based on known agent communication languages, such as KQML (Knowledge Query and Manipulation Language) ref: Finin, T.; Fritzson, R.; McKay, D.; McEntire, R. (1994). “KQML as an agent communication language”. Proceedings of the third international conference on Information and knowledge management—CIKM '94. p. 456. ISBN 0897916743. doi:10.1145/191246.191322., or FIPA-ACL (ref: Poslad, Stefan (2007). “Specifying Protocols for Multi-agent System Interaction”. ACM Transactions on Autonomous and Adaptive Systems. 4 (4). doi:10.1145/1293731.1293735.

To make agents and their actors understand each other they must not only speak the same language, but also share a common ontology with respect to information that is received in the messages and information that is provided in sent messages. Such an ontology is a part of an agent's knowledge base that describes what kind of things an agent can deal with and how they are related to each other. Information about an ontology used in a financial matters domain is set forth in U.S. patent application Ser. No. 15/593,870, filed on May 12, 2017, the entire contents of which are incorporated here by reference.

The actor execution engine 86 (e.g., a dispatcher) can reside on and be executed at a platform running on a server or in a cloud service, or can reside on a mobile device such as a smartphone, or a combination of a server and a mobile device.

Through the medium of its executable actors, a conceptual agent can do four main things: (1) perceive its environment (data, and other information), (2) act on its environment, (3) apply specific internal agent goals in doing its work, and (4) apply reasoning, inferencing, or planning to help reach the internal goals. The internal goal of a hosted agent is typically aligned with a preference or goal of a person who owns it.

Additional information about actor models and messaging can be found in Gul Agh, Actors: A Model of Concurrent Computation in Distributed Systems, MIT Press, 1986, and Reactive Messaging Patterns with the Actor Model: Applications and Integration in Scala and Akka, by Vaughn Vernon, Chapter 1, “Discovering the Actor Model and the Enterprise, All Over Again”, both incorporated by reference here.

Throughout our discussion, when we refer to agents those references also may be considered as references to actors of the agents, and when we refer to actors and their activities, those references also may be considered references to their agents.

### Example Financial Assistance Actors

In implementations in which the assistance being given to people is financial assistance, the actors can include financial assistance actors. The following table identifies in the left column a category of financial information activity or a facet of the financial domain. The right column identifies one or more actors and the activities for which they are configured with respect to the corresponding category or facet. As suggested by the table, activities of actors can involve acquiring information, analysis, actions, and predictions, among others.

| Category/Facet | Financial assistance actor or activity |
|---|---|
| Account Linking | Categorization |
| Profile analysis | Financial well-being assessment |
| | Cash allocation |
| | Refresh assessment and allocation |
| | Move ranking |
| Life Insurance | Find the cheapest provider |
| | Get the right life insurance coverage |
| Unsecured Debt | Lower the cost of interest |
| | Lower the monthly payment |
| | Predict loan approval |
| | Predict loan APR |
| | Predict credit card approval |
| | Predict credit card APR |
| Saving | Open reserves account |
| | Variable contribution to savings/reserves |
| Spending | Move to cash/debit |
| | Consolidate spending onto one card |
| | Get a better rewards card |
| | Time based spending interventions |
| Checking | Reduce the cost of your checking account |
| Auto Insurance | Get a cheaper auto provider |
| Paying for a home | Pick the right purchase mortgage and lender |
| | Home refinance |
| | How much house can be afforded? |
| | Should I buy a house? |
| | I need to finance home improvement |
| Household Bills | Find a better wireless plan |
| | Find a better cable plan |
| | Reduce subscriptions |
| | I need better wireless coverage |
| | Utilities |
| Credit | Repair Credit |
| | Build credit (thin file) |
| Dwelling protection | Get a cheaper home insurance provider |
| | Get the right home insurance coverage |
| | Automatic provider optimization |
| Personal Protection | Health insurance |
| | Identity Protection |
| | Umbrella Insurance |
| Paying for Education | Refinance student debt |
| | New Education finance |
| Major Purchase-how | I need to finance [ ] |
| should I pay? | Should I pay cash or finance [ ] |
| | How much can I afford for [ ] |
| Auto Purchase | Auto purchase financing |
| | Auto refinance |
| | How should I buy my next car? |
| | Do I need a car? |
| | What do I need to save for my next car? |
| | How much car can I afford? |
| Life stage changes | Merge finances with a partner |
| | Marriage |
| | Birth of Child |
| | Divorce |
| | Loss of spouse |
| | Job loss/Salary decrease |
| | Moving |
| | Income Change |
| Healthcare | Managing a healthcare savings account |
| | Shopping for a doctor |
| | Selecting the right plan options |

For example, for the facet called “Paying for a home”, respective actors are configured to pick the right purchase mortgage product and lender; analyze a home refinancing; determine how much house a person can afford; analyze whether, from a financial perspective, a person should buy a house; and analyze financing for home improvements.

A wide variety of other actors could be defined for various facets of personal finances including a shopping location finder; a product pricing comparison actor, a shopping decision (assessment) assistance actor; a shopping affordability actor; a price negotiator; an APR negotiator; and a payment actor to name a few.

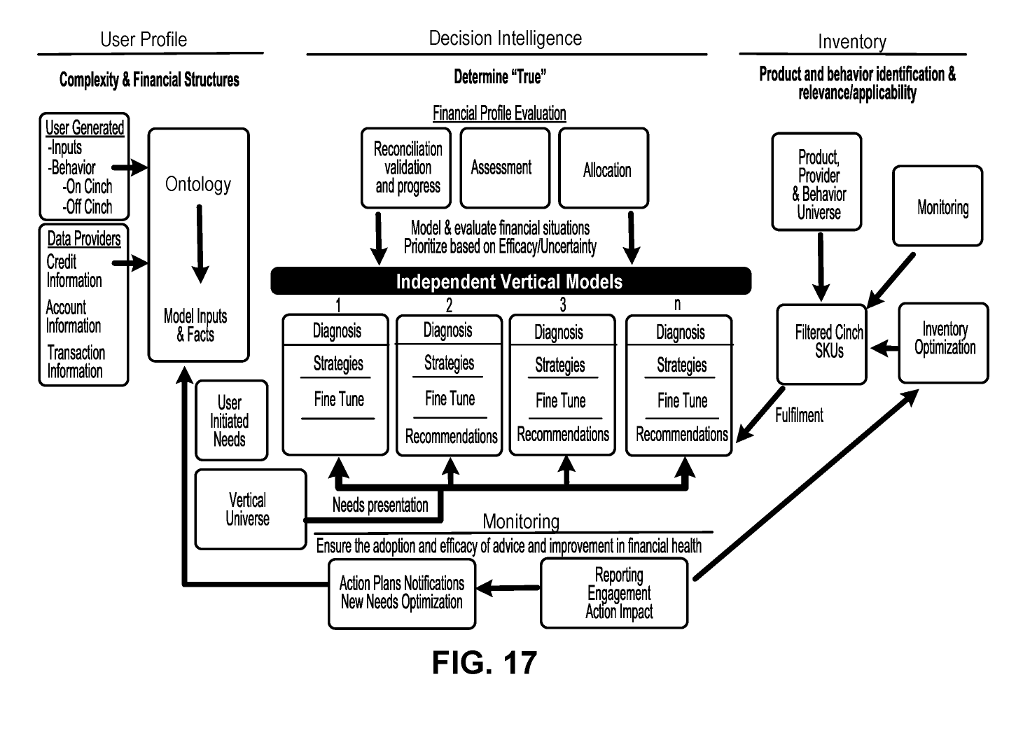

Examples of actors that can be used in a platform operating in the financial domain husband are shown in yellow in FIG. 17.

Actors can be implemented in a wide variety of ways using available development tools. Actor libraries or frameworks have also been implemented to permit actor-style programming in languages that don't have actors built-in. Information about actors, actor models, actor-style programming, and actor development tools can be found at https://en.wikipedia.org/wiki/Actor_model incorporated here by reference.

### Temporal and Locational Actors

Actors can include temporal information actors that are configured to send messages when defined temporal events occur. For example, an actor can be configured to send a message to a specified target actor when a defined clock event is triggered such as on Jan. 1, 2027, at 9:00 a.m. EST; 2. a weekly calendar event is triggered such as every Monday at 9:00 a.m. EST; or a combination calendar event is triggered such as in every quarter, in the first month, in the first week on Monday at 9:00 a.m. EST. The sending of messages when temporal events happen is useful in providing real-time assistance to people.

Actors also can include locational information actors that are configured to send messages when defined locational events occur. For example, an actor can be configured to send a message to a specified target actor when the actor is within 30 feet of a specific geo-location such as “lat”: “37.348929”, “lon”: “−121.888536” or the actor is within 30 feet of a specific retail store such as any Barnes & Noble bookstore. Triggering messages based on locational information enables platforms to provide assistance wherever a user is during the user's normal daily activities.

Providing assistance in real-time can significantly enhance the value of the assistance and can enable agents to provide assistance at times and places that could not normally be served by static assistance systems. Through platforms running at least partly on mobile devices, agents can also perform actions at real-time locations for the users to and the agents belong.

In some implementations, agents provide real-time assistance at real-time locations using augmented reality techniques described later. Augmented reality techniques also can be used to provide assistance in non-real-time and in non-real-time locations.

### Avatars

External visible aspects of the assistance provided by an agent to the person to whom it belongs can be delivered in a variety of presentation modes through a range of user interfaces on an array of different user devices. For example, text, numbers, and graphical elements can be presented in simple arrangements on a typical screen of a smart phone, and information can be received from the user through the smart phone user interface.

In some cases, the elements presented in the user interface can include an avatar 102 that is a representation of a conceptual agent 80. The avatar 102 can take the form of a graphical or animated element such as a cartoon character or a human actor. The avatar could be capable of speaking, moving, and listening, among other things, and therefore of personifying the agent. Using an avatar as a representation of the agent can enhance the user's willingness to listen to, process, and act on the assistance provided by the agent.

The avatar can be presented through a user interface 106 of a mobile device 108 of a user 110 by execution of one of the actors (e.g., actor 96) that represent the agent 80. A presentation component of the software of the platform can execute the actor by causing the avatar to appear. The actor 96 can be configured to provide text, numbers, speech, and motions of the avatar corresponding to actions of the other actors of the agent. The actor 96 can also receive alphanumeric text or audio or video input from the user 110 and pass it in one or more messages to one or more other actors representing the agent. Through these mechanisms, the user in essence can interact with the avatar for a wide variety of purposes associated with providing assistance such as financial assistance.

### Augmented Reality

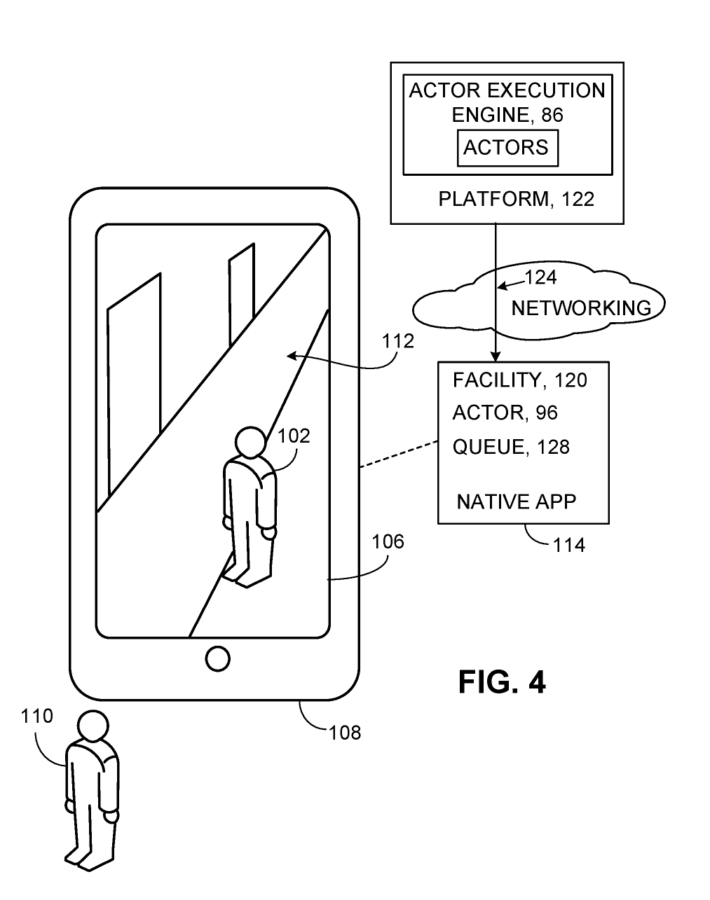

As shown in FIG. 4, in some cases, the avatar 102 is incorporated as an augmentation of a reality (e.g., a real scene 112 presented to the user 110 through the user interface 106 of the mobile device 108). As part of such an augmented reality, the avatar 102 can appear to be present in and to interact with features of the real scene 112. For example, the avatar can move within the real scene, can speak about and point out features of the real scene, and can listen to and receive other input from the user regarding the real scene or the assistance being provided by the avatar's agent. The avatar also can engage in other actions and behavior. For example, the real scene augmented by the avatar could be a view of a street along which a user is walking; the avatar could be a representative of an agent that can assist the user in taking the safest, most interesting, and aerobically challenging route through this part of the city; and the avatar could be talking the user along the route and pointing out sights along the way.

An augmented reality user interface can incorporate avatars to take advantage of human psychology in a positive way to present agents as trusted fiduciaries, not as manipulative adversarial parties. Game techniques can be used with avatars to engage consumers. In some cases, the technology that we describe here applies psychological and artificial intelligence principles to augmented reality scenarios to influence a consumer's behaviors.

Such an avatar can be presented by a native app 114 running on the mobile device 108 by executing one or more actors such as actor 96 of the agent 80. The native app includes a software facility 120 that presents the real scene, say, by capturing it continuously using a forward facing camera of the mobile device and displays the resulting video or still images in real time on the user interface. The native app also could receive, from other actors being executed on the platform 122 that hosts agent 80, information 124 (such as data to be presented to the user or input to be requested from the user) needed to present the avatar as an augmented feature of the real scene. The information 124 could define both the continuing presentation characteristics of the avatar, such as its physical appearance, its voice, its typical movements, and specific information needed to present the current actions and behavior of the avatar, such as things it should say or show to the user and information that it should request from the user. The software facility 120 of the native app would execute actor 96 to control the avatar in real time to engage in such actions and behavior.

During the presentation of the avatar, the actors executed on the mobile device send and receive messages among themselves wirelessly through the cellular network 126 to and from other actors of the agent being executed on the server. Although it would be possible for the avatar's actors executed on the mobile device to perform analytical tasks, in most cases those actors merely perform user interface presentation tasks for the avatar and pass information that is the subject of the interaction with the user back and forth to actors on the server. Other actors can also be executed on the mobile device for other purposes and those actors can communicate with the user interface actors on the mobile device and with other actors being executed on the server.

Actors being executed for a given agent can work together through the medium of messages exchanged between them. In addition, actors of a given agent use messages to communicate with actors of other agents to enable two or more agents to cooperate to do a job.

The actor execution engine 86 on the platform 122 and the facility 120 on the mobile device manage the process of passing messages among actors and the process of executing actors in response to receive messages. For this purpose, a queue 128 of actors on the mobile device that want to send messages and of actors on the mobile device that must act in response to received messages is maintained on the mobile device, and a similar queue 130 is maintained on the platform (FIG. 3). Each of the actor execution engine 86 and the facility 120 processes tasks from the corresponding queue, in order. When a task involves sending a message, the actor execution component picks up the message to be sent, associates it with the target actor, and places a task in the queue to cause the target actor to be executed in response to the message. Each task that involves executing a target actor in response to a message is also executed when it reaches the top of the queue.

In cases in which the message is to be sent from the mobile device to an actor on the platform, or from an actor on the platform to the mobile device, or from an actor on one platform controlled by one party to an actor on another platform controlled by another party, the actor execution component on the source platform forwards the message through the network to the actor execution component on the target platform where it is associated with the target actor and a task placed in the queue at the target platform.

A wide variety of implementations of avatars in augmented reality contexts on mobile devices would be possible. Developer toolkits are available, for example, from Google® and Apple®.

Apple provides an ARKit framework for presenting augmented reality on an iPhone or an iPad. The framework can be used to combine digital objects and information with the real-time presentation of a real scene in the vicinity of the device (https://developer.apple.com/arkit/).

Google provides an ARToolKit (https://archive.artoolkit.org/documentaion/doku.php?id=4_Android:android_about) which can be used to present augmented reality on android devices, especially mobile devices.

Augmented reality environments can also be used to help users identify, select, and authorize agents to provide assistance to them. For this purpose, in some implementations, one or more of the platforms or the assistance system can superimpose on a real scene presented on a mobile device, as augmented reality components, agents represented by avatars or other graphical elements. In some cases, one or more platforms or the assistance system can maintain and present to users through user interfaces a virtual environment that houses agents available for use in providing assistance. A user could invite such an agent to move from the virtual environment to a real environment at the current time and current locality of the user.

Taken together, features of the mobile device (e.g., the platform that it represents) together with the augmented reality capabilities provided by the operating system of the mobile device offer powerful opportunities for providing, for example, financial assistance to users with respect to facets and domains of their lives. For example, the combination of a mobile device and augmented reality capabilities can perform the following actions: (1) through hardware features of the mobile device determine and provide an accurate geo-location of the mobile device in real time and determine and provide temporal information in real time; and (2) through actors of agents executed by platforms including the mobile device platform and a server or cloud-based platform, understand and integrate information about the user's financial state for one or more facets of the financial matters domain in real time; capture personal goals and preferences at an earlier time point; predict a user's potential (financial) options in real time; evaluate potential (financial) options in real time; and generate and synthesize plans in real time.

Organizing Agents and Actors for Financial Assistance and Examples of their Use

To provide financial assistance to a consumer for one or more facets of the financial domain, typically a variety of financial agents are created on a platform, and the platform defines and establishes relationships of each created financial assistance agent with other financial assistance agents hosted on the platform. In some implementations, the agents that serve a consumer can be organized in three groups: agents whose actors analyze context and perform reasoning; agents whose actors perform trade-off analyses and synthesize plans, and agents whose actors perform execution and monitoring.

Some execution and monitoring actors perform actions that relate to augmented reality, for example, as temporal actors that are activated based on time and event triggers, and locational actors that are triggered based on a current location of the consumer. Actors and augmented reality are discussed in more detail below.

When each agent template is created for a platform, the actors that are required for agents to be spawned from that template to be able to provide the intended assistance are identified in the definition of the agent template.

Referring again to FIG. 3, just as agent templates can be used to define categories of agents, actor templates 162 can be used to define categories of actors. An actor template management component 160 can be executed on a platform to help the developer to define, create, remove, update, and manage actor templates. When a conceptual agent is created as an instance of an agent template, an actor creation component 164 running on the platform can create a record in the actor database 166. The record for each actor can include the following fields, for example: a globally unique identifier for the actor; identifiers for one or more agents to which the actor belongs; and identifiers for algorithms, routines, or other executable elements that the actor is to be capable of performing.

### Example Agents and Assistance in an Augmented Reality Context

An example of a configuration of actors that could be used to execute a student loan refinance agent could include an actor X that would represent the agent and implement a student loan avatar on a user's mobile device. A refinance student debt actor running on a fiduciary platform would determine a possibly good approach to refinancing a student loan based on information received from the user through the avatar and the actor X, information available on the platform about the financial state of the student, and information about available refinancing products, among other things.

In another example, a comprehensive spending agent could be implemented using the following actors: an actor X that would represent the agent and implement a comprehensive spending avatar on the user's mobile device; a move-to-cash/debit actor; a consolidate-spending-onto-one-card actor; a get-a-better-rewards-card actor; and a time-based-spending-interventions actor.

Actor templates are designed so that the actor instances spawned from them will perform the correct tasks and be able to interact with other actors through messages.

As shown in FIG. 5, in another example, when a user is at a retail store 200 (for example, Costco®), a receipt agent 202 can be presented as an avatar 204 through a user interface of the user's mobile device. The avatar can show to the user information 206 that has been collected by the receipt agent on the user's behalf. The information could include receipts for purchases made by the user at the retail store. The avatar can then invite the user to ask for more assistance 208, giving examples: show statistics for each category of product purchased or find specific receipts (for example, a receipt needed to return an item to the retail store).

FIG. 5 also illustrates a saving agent 203 represented by a saving avatar 205 displayed on the user interface. The avatar invites the user to request assistance and provides 212 a list of things that the avatar's agent can do for the user: Find any coupon for XXX? Check Amazon® price for XXX? Search for other stores where the price of XXX is cheaper?

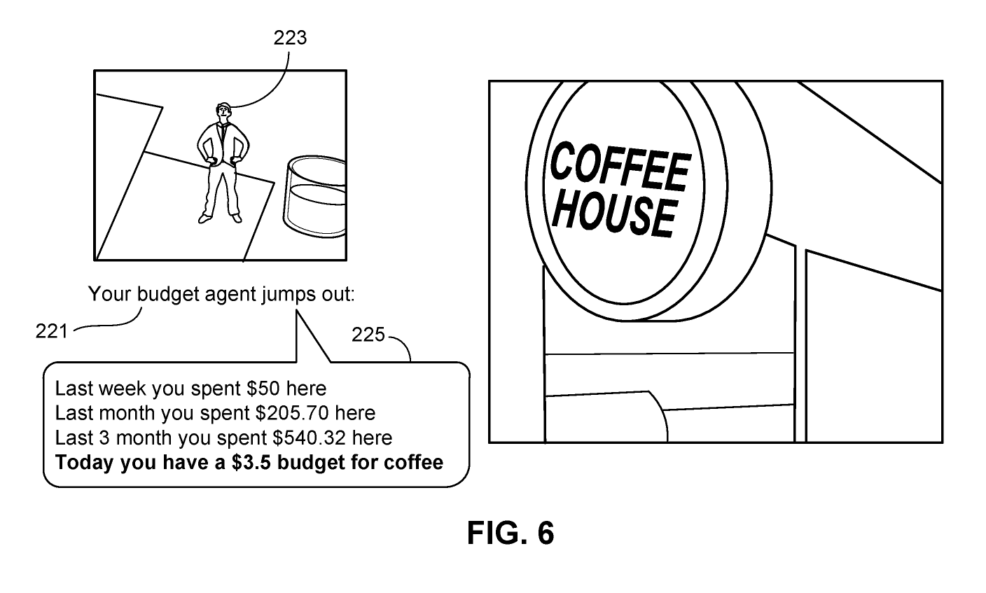

As shown in FIG. 6, a spending (e.g., budget) agent 221 presented to the user through a budget avatar 223 provides another example. Such an agent can perform the following actions: determine, based on cash flow and balance sheet analysis using information in the database, how much money the person has available for discretionary spending; recommend one or more payment devices the person should use to make purchases; provide a spending target on a daily/weekly/monthly basis; discuss with the person her goals for low frequency recurring spend (e.g. travel, summer camp); automatically accrue funds for low frequency recurring spend every pay period; notify a consumer when throttling spending will help maintain a balance; provide moment-in-time notifications when spending momentum is building, for example, if during the period leading into black Friday the user has a propensity to shop aggressively for the holidays based on historical behavior during that period); send geo-located or time based messages 225 when mindfulness is important and could limit spending by using a different payment method (e.g., on Thursday afternoon if the consumer tends to go out for drinks Thursday night suggesting using cash as opposed to his credit card); track spending and report back successful periods to the consumer, but not the full details.

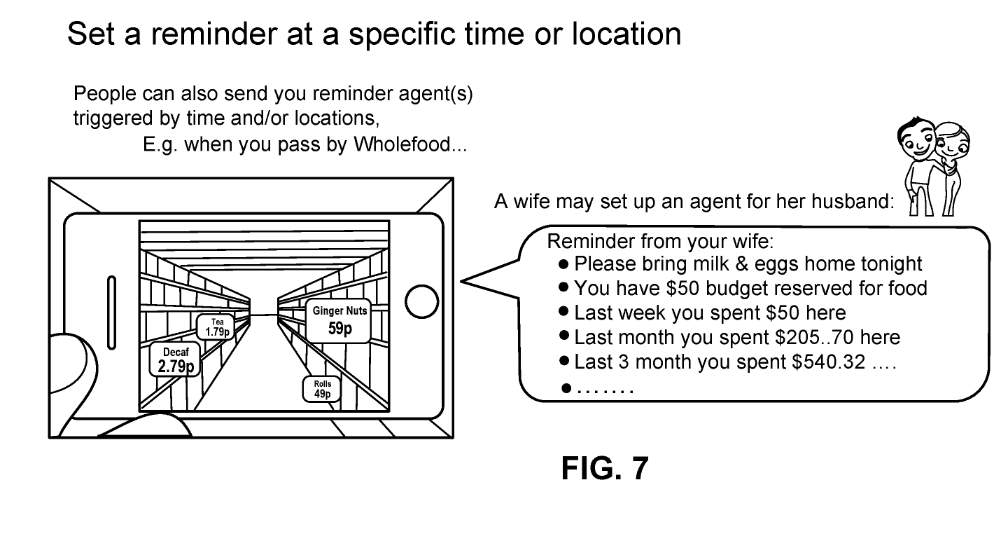

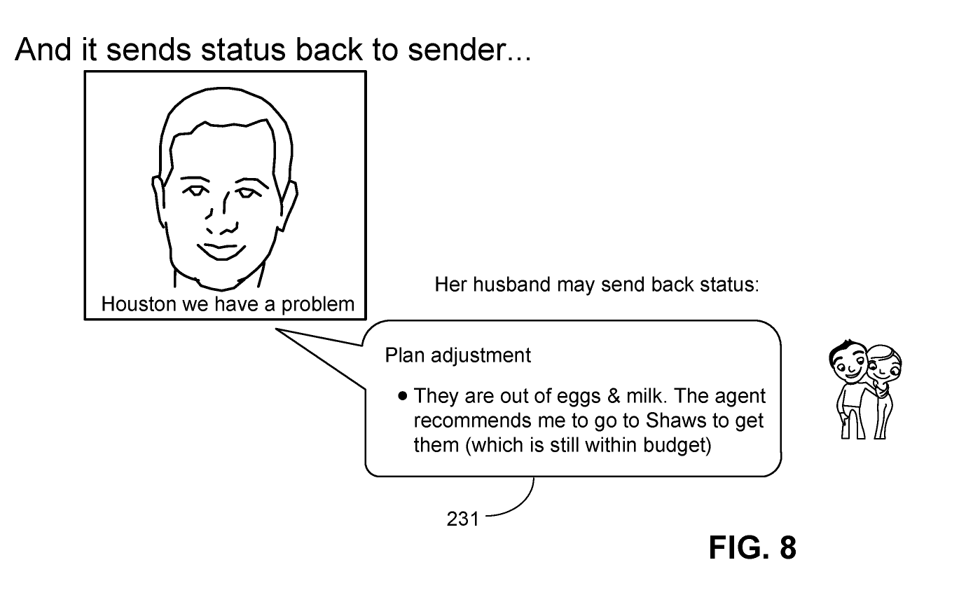

As shown in the example of FIG. 7, a reminder agent could perform the following actions: enable a user to set a reminder associated with a specific time or location or both; enable a user to send a reminder agent to another user, triggered by time or location or both (e.g., “when you pass by Wholefoods, pick up a quart of milk.”). As shown in FIG. 8, the reminder agent could receive a reply message 231 from the second user and send it back to the first user.

Other agents in the financial domain could include a mortgage agent, a student loan specialist agent, a banking expert agent, an auto insurance agent, or a life insurance expert agent, to name a few.

A range of different kinds of agents can be selected by a user to provide financial assistance as part of an augmented reality scene presented on his mobile device in real time, at his current location. In each case, the agent performs its actions through a set of actors, including an actor that presents the avatar representing the agent in the real scene on the user interface.

For example, suppose a user has a budget reminder agent configured to help him in real time at current locations by explaining how possible expenditures may impact his budget. The budget reminder agent could operate through the following actors:

1. An actor X which is responsible for representing the agent through an avatar in the user interface and to route actor messages.
2. A location actor Y configured so that when the user's mobile phone is located within 30 feet of a Starbucks store, actor Y sends a message to actor X (which will forward this message to a budget planning actor Z)
3. A budget planning actor Z configured so that when it receives the message from actor X that the user is at a location within 30 feet of the Starbucks, actor Z (which is being executed on a platform server) retrieves the spending history of the user related to Starbucks (by sending a message to a spending history actor W) stored on the platform. When actor Z receives a reply message from actor W, actor Z sends a message to actor X, forwarding the message from actor W, to cause actor X to display a message on the screen of the mobile phone providing a summary to the user of his spending history at Starbucks and of an amount budgeted for spending at Starbucks today. The budget is generated by or stored on the platform from which actor Z has sent its message.
4. A spending history actor W is configured to act on the message of actor Z forwarded by actor X to actor W by querying the database at the server and returning a message to actor X containing the spending history and daily budget amount related to Starbucks.
5. A budget reminder avatar-X actor is configured to cause a notification to be popped onto the screen next to the avatar that the avatar-X actor is currently presenting.

After the user departs the neighborhood of the Starbucks, the actors perform the following actions.

1. When the mobile phone passes beyond the range of 30 feet from the Starbucks, the location actor Y sends a “leaving” message to actor X (which will forward this message to budget planning actor Z).
2. When budget planning actor Z receives the “leaving” message, the budget planning actor Z retrieves the spending history of the user related to Starbucks (by sending a message to spending history actor W) and forwards the reply message from actor W to actor X to cause actor X to pop up a shopping event summary to the user.
3. The spending history actor W, when it receives the forwarded message of budget planning actor Z, queries the database at the server and returns the spending history related to Starbucks (this time, specifically focused on the most recent purchase at Starbucks).
4. The budget reminder avatar X actor then pops out a report to the user that can be either an encouragement message 241 and a positive score if the most recent purchase is within budget or a discouragement message 243 and a negative score if the most recent purchase is above the budget. The messages and the scores can be based on information stored in the database and retrieved by the spending history actor W.

The examples provided above relate to an agent and its actors that are providing assistance to a single person with respect to activities of that person. No other person is involved.

In many cases, however, agents that belong to different people or enterprises can provide assistance to a combination of two or more people at a time with respect to activities of two or more of the people.

1. For example, suppose a woman wants to engage the help of her budget reminder agent X2 to interact with her husband about a grocery store visit. Agent X2 is represented by an avatar displayed on her phone enabling her to control its appearance on her husband's phone.
2. An actor X1 of an agent X1 that belongs to the husband is configured to provide identity representation for agent X1 (that is, actor X1 is the electronic alter ego of the husband for purposes of activities and messages of other actors that relate to the husband) and to route all messages.
3. Actor X1 receives a message from actor X2, acting for agent X2, representing the wife, and containing an initial shopping list.
4. When the husband's mobile phone location is within 30 feet of a particular retail store, a location actor Y1 sends a message to actor X1 (which will forward the message to a budget planning actor Z1).
5. When the budget planning actor Z1 receives the forwarded message, the budget planning actor Z1 retrieves the spending history of the husband related to grocery shopping (by sending a message to spending history actor W1). When a reply message is received from the spending history actor W1, it causes a summary to be popped up on the husband's phone (by forwarding the reply message from W1 to actor X1)
6. When spending history actor W1 receives the forwarded message of budget planning actor Z1 from actor X1, spending history actor W1 queries the database at the server and returns to actor X1 a message containing the husband's spending history related to grocery shopping.
7. When actor X1 forwards the spending history for the particular retail store, a budget-reminder avatar X1′ actor causes the avatar X1′ to present a pop up notification to the husband on his phone.
8. The avatar's actor can then receive information entered by the husband through the user interface of his phone to indicate that items on the grocery list are not available at the particular retail store.
9. When the husband's mobile phone leaves the 30-foot zone around the particular retail store store, the location actor Y1 sends a “leaving” message to actor X1 (which will forward the “leaving” message to budget planning actor Z1)
10. When the budget planning actor Z1 receives the “leaving” message, actor Z1 retrieves the spending history of the husband at the particular retail store by sending a message to spending history actor W1. When a reply is received, the actor Z1 forwards it to actor X1 to cause a pop up on the husband's phone to show a shopping event summary.
11. When the spending history actor W1 receives the forwarded message from actor X1, actor W1 queries the database at the server and sends a reply message containing the spending history related to the particular retail store (this time, specifically focused on the most recent shopping session at the particular retail store).
12. Actor X1 receives the message containing no new purchase records and infers that the items in the shopping list are not available at that particular retail store for some reason. Then actor X1 sends a message to and alternative shopping location finder actor.
13. The alternative shopping location finder actor receives the message and identifies the nearest next shopping location that has the items on the shopping list and sends a message containing this information back to actor X1.
14. Actor X1 forwards the alternative shopping locations to the budget-reminder avatar X1′ actor to cause the avatar X1′ to present the alternatives on the phone of the husband. The husband may then decide to go to one of the alternative stores and enters information about his plans through the user interface to his agent X1 which sends the message to the wife's agent X2. The wife's agent X2 causes its avatar to present the information from her husband to her on her phone.

In addition to mediating communications between two people who are participants in a single fiduciary platform, agents can facilitate interactions between a user and a third party. In such cases, the agent of the third party may be a partisan agent.

As shown in FIG. 10, an example of such an interaction is based on a user interacting with an augmented reality app 262 called IKEA® Place available for use on the Apple iPhone®.

In this example, suppose a consumer is using her mobile phone 260 to work with IKEA Place. The display on her phone shows a real environment, such as her living room 264. IKEA Place identifies IKEA products that could be placed in her living room and using augmented reality capabilities of the iPhone operating system augments her real living room with images of furniture 266 placed in the living room.

As shown in FIG. 11, an IKEA sales agent 272, one that belongs to IKEA and to its assistance platform could provide product and financial information related to IKEA products to a fiduciary budget agent 274 belonging to a user (e.g., consumer) 270. The arrows in FIG. 11 show communications among the user and the two agents as time progresses from left to right. In this example, the user has communications with the IKEA sales agent (a partisan agent) through the user interface provided by IKEA Place and communications with the budget agent through the user interface of the native financial assistance app also running on the mobile device.

The fiduciary budget agent of the consumer then provides financial assistance to the consumer in connection with a proposed purchase of an item of furniture, taking account of the information provided by the IKEA sales agent, to aid a decision by the consumer whether to buy the illustrated product. The consumer could then interact directly with the IKEA sales agent to make a purchase decision, which could then be conveyed by the IKEA sales agent to the fiduciary budget agent of the consumer. The fiduciary budget agent then could revise the consumer's budget plan and execute and monitor the revised budget plan with respect to the consumer's purchasing activity.

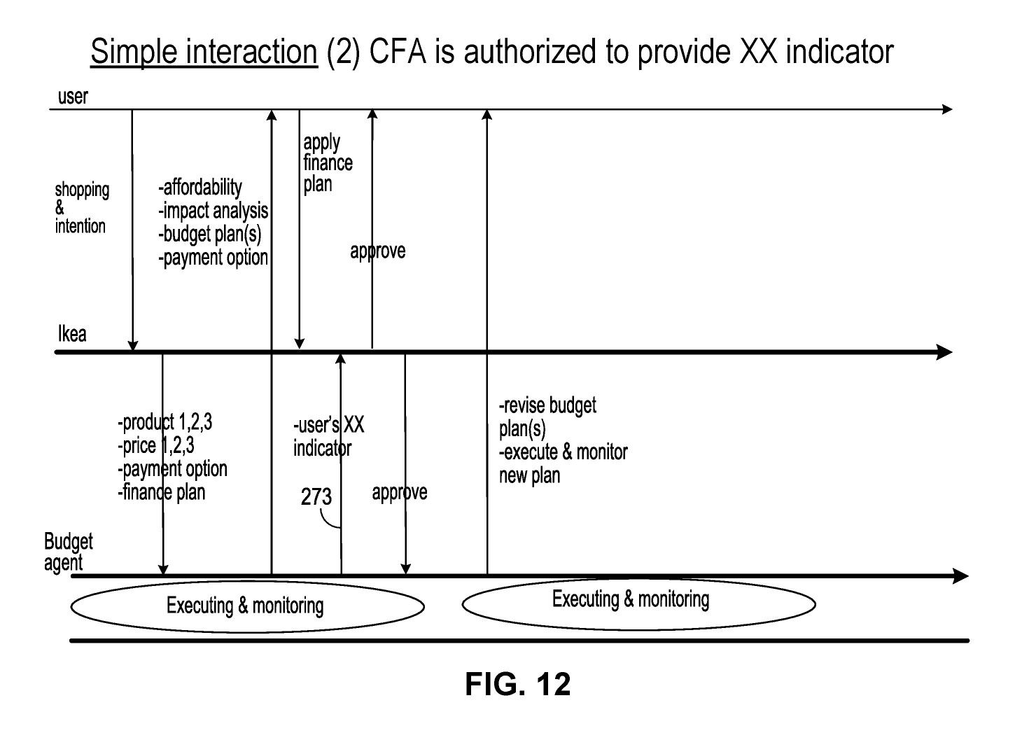

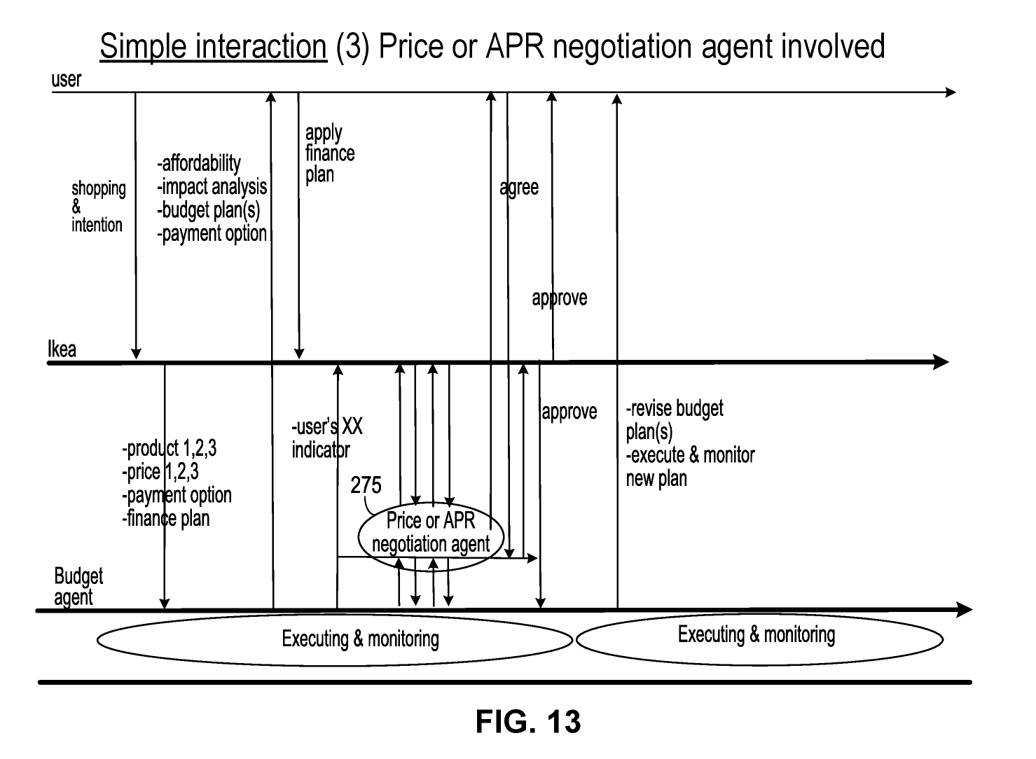

In this example, the financial budget agent does not provide any of the consumer's personal financial information (to which the agent has access on the server of the fiduciary platform) directly to the IKEA sales agent. In some cases, such personal financial information (say a budget amount) could be provided directly to the IKEA sales agent (as illustrated in FIG. 12), or a direct negotiation 275 (as illustrated in FIG. 13) could occur between the IKEA sales agent and the fiduciary budget agent. More complex examples can involve multiple fiduciary agents and partisan agents that belong to two or more platforms, multiple people, or multiple decision points, and combinations of them.

As shown in FIG. 12, in an example of two agents interacting directly to provide assistance to a user to whom one of the agents belongs, consider an agent X0 hosted by an IKEA platform, registered on a governing platform, and represented by an actor X0. Assume the user has a fiduciary shopping assistance agent X1.

In this scenario, actor X1 provides identity representation for agent X1 (and in turn for the user) and serves as a router of messages. Suppose the actor X1 has knowledge of an initial shopping item and related information about the item provided by actor X0 (representing IKEA). Actor X1 provides this information in a message to a shopping affordability actor Y1 of an agent of the user.

When the shopping affordability actor Y1 receives the shopping item message from actor X1, actor Y1 sends a message to an assessment actor Z1 of the user to evaluate the impact.

For this purpose, actor Z1 may send messages to other agents (not identified here) of the same cooperation group to get information needed in making an assessment, for example, actor Z1 may ask for assessments of individual relevant factors.

When reply messages from all of the cooperating agents have been received by the assessment actor Z1, actor Z1 aggregates the assessment and sends it in a message to the shopping affordability actor Y1.

The shopping affordability actor Y1 forwards a message containing the results back to actor X1.

Actor X1 forwards the affordability report and avatar X1's actor presents the report through the avatar to the user. If the user decides to proceed with the purchase of the shopping item, the user may also be interested in applying for Ikea's finance plan. If so, the user notifies actor X1 of that interest.

Once actor X1 receives the message indicating that it should proceed with the finance plan, actor X1 forwards the message to an APR negotiation actor M.

When the APR negotiation actor M receives the message from actor X1, the APR negotiation actor M sends a message to IKEA's actor X0 including the user's financial affordability indicator (which depends on the contract status of the user). This message from actor and to actor X0 starts an application & negotiation process, which can be an iterative, as the diagram illustrates.

Once the actor X0 receives the user's affordability information, actor X0 makes a decision on the offer on behalf of IKEA and sends a message containing a proposed APR back to the APR negotiation actor. This negotiation process can be iterative.

Once a potentially best deal message is received by actor X1 from actor M, actor X1 forwards the deal in a message to actor X1. Actor X1 then causes the avatar X1 actor to present the deal to the user through the avatar X1. The user can respond through the user interface of the phone to indicate his approval. Then the avatar X1 actor sends a message to actor X1 to report the approval. Actor X1 forwards the message to the APR negotiation actor which then forwards it to the IKEA actor X0, which finishes the paperwork for the financing transaction and sends a message with the paperwork to a payment actor N (which may belong to a third-party payer platform). Payment actor N processes the payment and sends a confirmation message back to actor X1. Actor X1 processes the message and updates the user's state and then forwards the message to avatar X1 actor, which presents the confirmation to the user through the avatar X1 on the screen of the user's device.

As shown in FIG. 14, another example could involve a long-term house purchase scenario involving multiple people, multiple third parties, and their agents, and multiple decision points over time.

In this case, a partisan seller agent X0 belongs to a platform of a seller's broker, is registered on a governing platform, and is represented by an actor X0. Another partisan agent X5 belongs to a platform of a mortgage company, is registered on the governing platform, and is represented by an actor X5. Two users 1, 2 (for example a husband and a wife) are involved in this scenario, each having a fiduciary home buying assistance agent X1H, X2H, respectfully. The home buying assistance agents are respectfully represented by identity actors X1H, X2H. there also are two mortgage assistance agents X1M, X2M belonging to the platform of the mortgage company and represented by corresponding identity actors X1M, X2M.

These agents and actors are configured to act and interact as follows.

Suppose users 1 and 2 visit a house and want to purchase it. The users report their interests independently through the user interfaces of their phones to their agents X1H and X2H.

Actors X1H and X2H receive the home buying messages and related information from the users, and in turn send messages to actor X0 requesting details associated with a possible purchase. Once messages containing the details are received from the actor X0, the actors X1H and X2H forward those messages to assessment actors Z1 and Z2, respectively, to evaluate the impact of proposed terms of the purchase. For this purpose, each of the assessment actor Z1 and Z2 may send query messages to other actors belonging to a cooperation group. When all of the actors in the cooperation group have finished their evaluations and sent messages back with the results, each of the assessment actors Z1 and Z2 aggregate the assessments and send messages containing the aggregated assessments back to actors X1H and X2H.

The actors X1H and X2H then forward the messages to respective avatar actors X1H′ and X2H′ which then cause the corresponding avatars X1H′ and X2H′ to present the assessments through the user interface to the respective users present to the user. Each user can then indicate through the avatars presented on the user interface whether he or she is interested in making a purchase. If so, the messages are forwarded by the avatar actors X1H′ and X2H′ to actors X1H and X2H.

The actors X1H and X2H treat the received messages as instructions to proceed to negotiate with the seller agent X0. X1H and X2H then forward the messages to a price negotiation actor M1 (a single actor that represents both X1H and X2H assuming the house is a joint purchase).

Once the negotiation actor M1 has received the messages, actor M1 sends a message to the seller actor X0 proposing a purchase offer. M1 then waits for a reply message from X0. Offers and counter offers can then be sent back and forth in messages iteratively as part of the negotiation process until an offer of actor M1 or actor X0 is acceptable to the other indicating that a deal has been reached.

Once a deal has been reached, the price negotiation actor M forwards the message to actors X1H and X2H and sends a message to mortgage assistance actors X1M and X2M.

Actors X1H and X2H then send messages to avatar actors X1H and X2H causing them to present the seller's decision on the deal through the avatars X1H and X2H on the user interfaces of the phones of the two users. If the seller's decision was to accept the offer, the avatars X1M and X2M will be caused by avatar actors X1M and X2M to pop out and gather users' preference regarding the mortgage.

Actors X1M and X2M then send messages forwarding the mortgage preferences to the APR negotiation actor, which then forwards the message to actor X5 in order to apply for a mortgage and negotiate the APR. The actors X1M and X2M also provide the users' financial affordability indicator.

Negotiation of the APR can be an iterative process as FIG. 14 illustrates.

After the actor X5 receives the user's affordability information, actor X5 makes a decision on the offer and sends a message containing the decision back to the APR negotiation actor. Once a potential good deal has been reached by iterative negotiation, the APR negotiation actor M forwards the most recent offer message from the actor X5 to actors X1M and X2M, which passed the messages to their avatar actors X1M′ and X2M′. Actors X1M′ and X2M′ then cause the proposed deal to be presented by avatars X1M′ and X2M′ through the user interface is on the phones of the two users asking for decisions by the two users. Once each of the users makes up his or her mind, he or she indicates the decision through the user interface to their respective actors X1M and X2M.

Actors X1M and X2M send messages forwarding the decisions to APR negotiation actor. The APR negotiation actor then sends a joint message carrying the decision to the actor X5, prepares the paperwork. (Later, once the house purchase is closed and the in mortgage officially signed, the APR negotiation actor sends a message reporting the mortgage deal to a payment actor N.) The actors X1M and X2M send messages to X1H, X2H, and X0 to schedule house purchase closing, and present to the schedule to the users user through avatars X1M′, X2M′. At the closing, the two users sign the paperwork to complete the transaction and mortgage payment. Then actors X0 and X5 will send messages confirming the closing to X1H, X2H, X1M, and X2M properly. X1M and X2M will send messages to payment actor N to begin the payment process in the proper amount.

In some examples, the scenario described above could be accomplished by a single fiduciary agent representing both parties.

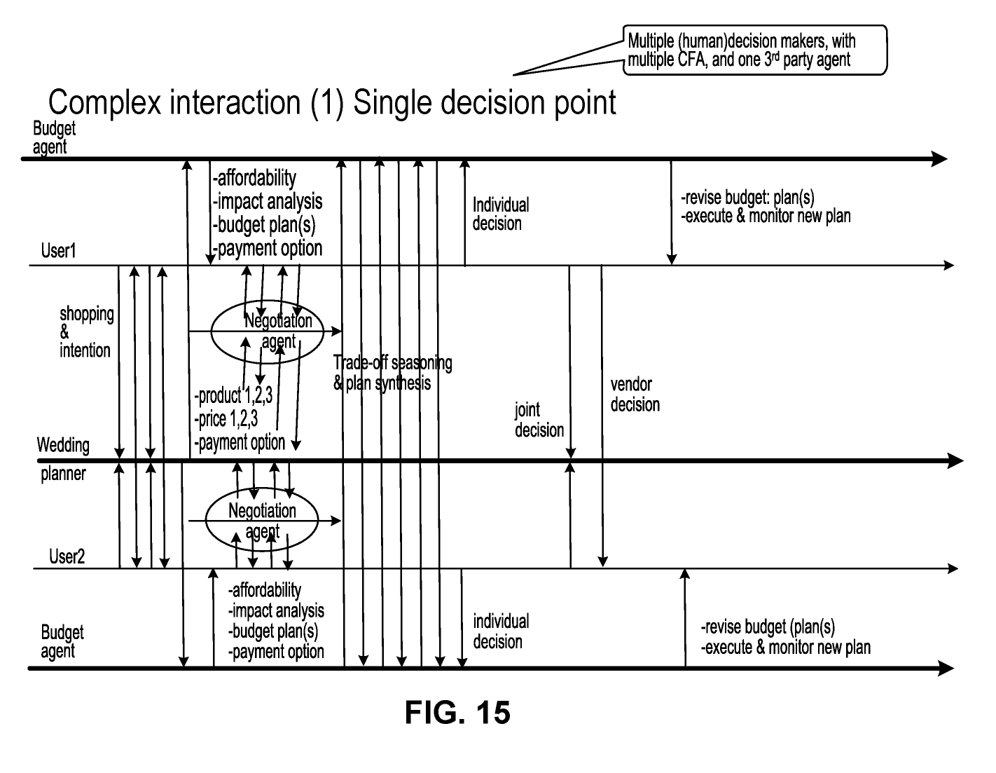

An example involving multiple decision makers and multiple agents one of which is a partisan agent of a third-party, and a single decision point is illustrated in FIG. 15 in the context of wedding planning.

Although we have described examples of agents assisting users in augmented reality contexts in which there is a direct relationship between a transaction or a decision in that context and the actions of the agents, in some examples, there need not be such a direct connection. Instead, the scene that is being augmented may not have aspects (such as the presence of a particular retail store) that involve a specific transaction or decision but instead may be a more mundane scene that can be augmented by an avatar of an agent whose role is to induce a consumer to think differently about a budgeting decision, for example, the scene is at home and the agent augments (e.g., changes) the landscape to reflect the vacation that the consumer needs to save for in six months.

### CONCLUSION

The technology that we have described integrates capabilities of assistance platforms (such as a governing financial platform) and agents (such as financial assistance agents) with capabilities of mobile devices to know a consumer's geographic location and temporal information in real time. The assistance platforms and agents provide the capabilities of understanding a user's holistic financial context in real-time; recalling goals and preferences of the user in real-time; predicting the user's potential options in real-time; evaluating those options in real-time; and generating plans in real-time. Because the combined capabilities of the mobile device, the advice platform, and the agents are all available in real-time, a variety of powerful features can be exposed to the user through the mobile device in real time, in particular by presenting the agents (e.g., its actors) as, for example, avatars in augmented reality scenes.

Artificial intelligence techniques can be used to analyze a user's state, predict potential actions and success rates, and recommend solutions. The agents can be presented to the consumer and interact with the user within an augmented reality scene, at the right time, the right location, and within the right context.

Actions that can be made part of the capability of agents (e.g., financial agents) include implementations of long-term goals and of criteria to be applied to trade-off analysis (such as trading off available cash against lower total interest payments, in the financial matters domain).

Other implementations are also within the scope of the following claims.

1. A system comprising
a mobile device having
a processor,
a camera configured to capture a real scene in a vicinity within a field of view of the camera at a current time,
a geolocation facility configured to determine a current geographic location of the mobile device at the current time,
a wireless communication component configured to communicate the current geographic location to a server,
a display screen,
the processor being operationally coupled to the camera, the geolocation facility, the wireless communication component, and the display screen, and
a storage for instructions executable by the processor to
cause the camera to capture the real scene in the vicinity within the field of view of the mobile device at a current time,
cause the geolocation facility to determine the current geographic location of the mobile device at the current time,
present an augmented reality scene on the display screen at the current time, the augmented reality scene comprising at least part of the captured real scene and an animated incarnation of a human or other creature representing a non-human financial assistance agent of person using the mobile device, the animated incarnation of the human or other creature being presented to augment the real scene,
communicate the current geographic location to a server using the wireless communication component,
the server configured to cooperate with the mobile device to present the augmented reality scene on the mobile device to the person using the mobile device at the current time, the server having a processor and a storage for instructions executable by the processor to
execute an interaction between the non-human financial assistance agent of the person using the mobile device and a non-human financial agent of another party associated with a feature appearing within the real scene, the interaction being related to a possible transaction to occur at the real scene, the interaction having a result based on known information about personal finances of the person using the mobile device at the current time, and
cause the result to be communicated to the mobile device in real time,
the instructions stored in the storage of the mobile device executable by the processor of the mobile device to
cause the wireless communication component of the mobile device to receive the result from the server, and
cause the animated incarnation of a human or other creature representing the non-human financial assistance agent of the person using the mobile device to present to the person using the mobile device, in accordance with fiduciary principles, information about the result in the augmented reality scene on the display screen at the current time.

2. The system of claim 1 in which the instructions executable by the processor of the mobile device comprise a native app installed on the mobile device.

3. The system of claim 1 in which the possible transaction is between the person and a retail business associated with the non-human financial agent of the other party.

4. The system of claim 3 in which the instructions are executable by the processor of the mobile device to receive from the person information about the possible transaction, to communicate the information to the server using the wireless communication component, to receive from the server additional information to be provided in the augmented reality scene by the animated incarnation of a human or other creature representing a non-human financial assistance agent of the person using the mobile device, and to cause the animated incarnation of a human or other creature representing a non-human financial assistance agent of the person using the mobile device to provide the information in the augmented reality scene.

5. The system of claim 4 in which the additional information depends on the current personal finances of the person.

6. The system of claim 4 in which the presentation of the representation of the non-human financial assistance agent in the augmented reality is triggered by another person who is a blood relative of the person using the mobile device.

7. The system of claim 1 in which the real scene is captured by a financial assistance app running on the mobile device.

8. (canceled)

9. The system of claim 4 in which the-mobile device comprises a user interface, and the information is received from the person through the user interface about the possible transaction.

10. (canceled)

11. The system of claim 1 in which the interaction comprises a negotiation.

12. The system of claim 1 in which the real scene comprises at least one of a room in an apartment or house; an interior space or an exterior surface of a retail store; a sidewalk, street, or building façade in a city or town; or a yard, street, sidewalk, or façade of a house.

13. The system of claim 1 in which the animated incarnation of a human or other creature representing a non-human financial assistance agent of the person using the mobile device is caused to gesture, gesticulate, appear, speak, listen, communicate, answer, ask, or advise with respect to the real scene.

14. A computer-based method comprising
a camera of a mobile device capturing a real scene at a place at a current time,
a geolocation facility of the mobile device determining a geographic location of the place at the current time,
a display of the mobile device presenting an augmented reality scene on a display screen at the current time, the augmented reality scene comprising at least part of the captured real scene and an animated incarnation of a human or other creature representing a non-human financial assistance agent of the person using the mobile device and augmenting the real scene,
a wireless communication component of the mobile device transmitting the geographic location,
the mobile device receiving information about a result of an interaction between a non-human financial assistance agent of a person using the system and a non-human financial agent of another party, the non-human financial assistance agent of the person acting in conformity with defined fiduciary principles with respect to the person in the interaction, the result being based on known information about personal finances of the person at the location at the current time, and
the animated incarnation of the human or other creature representing the non-human financial assistance agent of the person using the mobile device presenting information about the result in the augmented reality scene.

15.-27. (canceled)

28. The system of claim 1 in which the non-human financial agent of the other party is not bound to act in conformity with defined fiduciary principles with respect to the person using the mobile device.

29. (canceled)
